(19) United States
(12) Patent Application Publication
(10) Pub. No.: US 2016/0366882 A1
(43) Pub. Date: Dec. 22, 2016

(54) AGROCHEMICAL COMPOSITIONS FOR INDUCING ABIOTIC STRESS TOLERANCE

(71) Applicants: VIB VZW, Gent (BE); UNIVERSITEIT GENT, Gent (BE)

(72) Inventors: Frank Van Breusegem, Gent (BE); Dominique Audenaert, Opbrakel (BE); Jordi Denecker, Gent (BE); Pavel Kerchev, Gent (BE); Per Mühlenbock, Lidingö (SE)

(21) Appl. No.: 14/651,208

(22) PCT Filed: Dec. 13, 2013
(86) PCT No.: PCT/EP2013/076534

§ 371 Date: Jun. 10, 2015

Related U.S. Application Data
(60) Provisional application No. 61/737,634, filed on Dec. 14, 2012.

(51) Int. Cl. A01N 37/38; A01N 43/40

(52) U.S. Cl. CPC A01N 37/38; A01N 43/40

(57) ABSTRACT

The disclosure relates to agrochemical formulations and uses thereof for inducing abiotic stress tolerance in plants. More specifically, the disclosure provides agrochemical compositions comprising compounds with formula (I) which are useful to increase abiotic stress tolerance in crops.

### CROSS-REFERENCE TO RELATED APPLICATIONS

This application is a national phase entry under 35 U.S.C. §371 of International Patent Application PCT/EP2013/076534, filed Dec. 13, 2013, designating the United States of America and published in English as International Patent Publication WO 2014/090988 A1 on Jun. 19, 2014, which claims the benefit under Article 8 of the Patent Cooperation Treaty and under 35 U.S.C. §119(e) to U.S. Provisional Patent Application Ser. No. 61/737,634, filed Dec. 14, 2012.

### TECHNICAL FIELD

The disclosure relates to agrochemical formulations and uses thereof for inducing abiotic stress tolerance in plants. More specifically, the disclosure provides agrochemical compositions comprising compounds with formula (I), which are useful to increase abiotic stress tolerance in crops.

### BACKGROUND

Abiotic stress responses are important for sessile organisms such as plants because these organisms cannot survive unless they are able to cope with environmental changes. The term “abiotic stress” includes numerous stresses caused by complex environmental conditions, e.g., strong light, UV, high and low temperatures, freezing, drought, salinity, heavy metals and hypoxia. These stresses will increase in the near future because of global climate change, according to reports from the Intergovernmental Panel of Climate Change on the World Wide Web at ipcc.ch. In the European heatwave of 2003, crop production was reduced by around 30%. Therefore, understanding abiotic stress responses is now thought to be one of the most important topics in plant science. Traditionally, the successes in breeding for generating better adapted varieties to abiotic stresses depended upon the concerted efforts by various research domains including plant and cell physiology, molecular biology and genetics. Major progress in this research field has come from the application of molecular biology. Furthermore, after this methodology was employed in plant science, many abiotic stress-inducible genes were isolated and their functions were precisely characterized in transgenic plants. The availability of these data broadened and deepened our view of abiotic stress responses and tolerance in plants. Yet another approach to enhance the abiotic stress tolerance of plants is the identification of agrochemicals which are able to confer abiotic stress tolerance on plants. Photorespiration (Rp) is particularly enhanced during abiotic stress and is a major source of detrimental effects and yield losses in crop plants. Attempts to interfere with photorespiration in plants have, thus far, been met with very limited success. Catalase is one of the crucial proteins in the Rp process since it provides the dissipation sink of photosynthetic excitation overload in the role of Rp as a photoprotective mechanism. Catalase-2 mutants are particularly vulnerable to the effects of photorespiration because they are unable to cope with the accumulation of H₂O₂ during high light stress and cannot survive. In the disclosure we used a catalase-2 knock out mutant of Arabidopsis thaliana in a high-throughput screening for the selection of chemicals that are able to overcome plant cell death due to photorespiration damage.

### BRIEF SUMMARY

The disclosure shows that a class of molecules represented by formula (I) shows an unexpected increase of abiotic stress tolerance when applied on plants.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: In the high-throughput plant screen, we first optimized the detection of a decrease in Fv/Fm in A. thaliana catalase-2 mutants grown in 96 well plates. The phenotype, which develops gradually in 1 week-old seedlings over a period of 7 days consists of a significant and highly repeatable decrease in Fv/Fm that can be simultaneously detected by chlorophyll fluorescence imaging and by individual Fv/Fm quantification for each well in a non-destructive manner, using a Walz Imaging PAM. Our efforts have led to a fast and robust protocol for the production of highly reproducible standardized, color coded images of Fv/Fm. In the images, a blue color represents healthy plants (in this case the wild-type, Col-0), whereas the green color in the catalase-2 mutants represents a 20-50% reduction in Fv/Fm. In the screen we aimed for the identification of chemical compounds that were able to significantly reduce the observed decrease in Fv/Fm. In this screen compounds were identified that “keep seedlings blue” and prevent them from “turning green.”

FIG. 2: effect of 5 μM of compound 4 on the rescue of cell death of the catalase-2 mutant A. thaliana plantlets when grown under photorespiratory conditions. Photorespiratory conditions are, for example, as herein used, restricted-gas-exchange-constant light conditions. The left panel (upper part) shows the Col-0 A. thaliana wild-type plant. The lower part shows cell death of the cat2-2 mutant of A. thaliana. The right panel shows (upper part) the Col-0 A. thaliana wild-type plant in the presence of 5 μM of compound 4. The lower part clearly shows the rescue of cell death of the cat2-2 A. thaliana plant in the presence of 5 μM of compound 4.

FIG. 3: chlorophyll fluorescence imaging of Col-O and catalase 2-mutant plants. The right panel (lower part) clearly shows the rescue of 5 μM compound 4 of the cell death in the cat2-mutant plants.

FIG. 4: increased growth of wild-type and cat2-2 plants treated with chemical compound 4. Both the left and right panels are obtained under normal growth conditions (i.e., no high light conditions). It can be observed that the right panel, grown in the presence of compound 4 (5 μM), has an enhanced yield as compared to the control (left panel, no compound 4).

FIG. 5: compound 4 (5 μM) rescues cell death of the cat2-2 mutant. Non-treated and treated plants are grown under photorespiratory conditions.

FIG. 6: variant 1 (100 nM) rescues cell death of the cat2-2 mutant. Non-treated and treated plants are grown under photorespiratory conditions.

FIG. 7: variant 2 (50 nM) rescues cell death of the cat2-2 mutant. Non-treated and treated plants are grown under photorespiratory conditions.

FIG. 8: growth under high salt conditions (200 μM NaCl). Left panel shows plantlets of A. thaliana (Col-0) in the presence of 200 μM NaCl, growth defects are clearly visible. The right panel shows the growth of A. thaliana plantlets in the presence of 200 μM NaCl and 5 μM of compound 4, one can clearly observe a positive effect on the growth defects of compound 4.

FIG. 9: Crop condition index (0-100) of maize plants after 6 hours of frost regime (−2° C.) following treatment with dichloroprop-P at different concentrations, assessed 2 days after treatment

FIG. 10: Maize plants after 6 hours of frost regime (−2° C.) following treatment with dichloroprop-P at 4 mg/l (4 pots on the left) or untreated (4 pots on the right).

FIG. 11: Vitality index (0-100) of oilseed rape plants after salt water irrigation following treatment with dichloroprop-P at different concentrations assessed 3 and 4 days after treatment.

FIG. 12: Oilseed rape plants after salt water irrigation following treatment with dichloroprop-P at 4 mg/l (4 pots on the right) or untreated (4 pots on the left).

### DETAILED DESCRIPTION

The disclosure will be described with respect to particular embodiments but the disclosure is not limited thereto, but only by the claims. Any reference signs in the claims shall not be construed as limiting the scope. Where the term “comprising” is used in the present description and claims, it does not exclude other elements or steps. Where an indefinite or definite article is used when referring to a singular noun, e.g., “a” or “an,” “the,” this includes a plural of that noun unless something else is specifically stated.

The following terms or definitions are provided solely to aid in the understanding of the disclosure. Unless specifically defined herein, all terms used herein have the same meaning as they would to one skilled in the art of the disclosure. Practitioners are particularly directed to Sambrook et al., Molecular Cloning: A Laboratory Manual, 4^{th} ed., Cold Spring Harbor Press, Plainsview, N.Y. (2012); and Ausubel et al., Current Protocols in Molecular Biology (Supplement 100), John Wiley & Sons, New York (2012), for definitions and terms of the art. The definitions provided herein should not be construed to have a scope less than understood by a person of ordinary skill in the art.

In crop protection, there is a continuous need for compositions that improve the health of plants. Healthier plants are desirable since they result among others in better yields and/or a better quality of the plants or crops. Healthier plants also better resist to biotic and/or abiotic stress.

Provided is a compound of formula (I) or a stereoisomer, a tautomer, a hydrate, a solvate, or a salt thereof, i.e.,

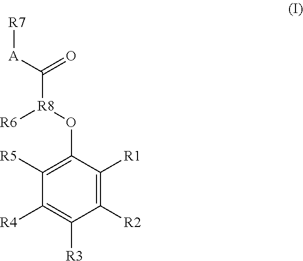

wherein in (I)

R1 is halogen, hydrogen or methyl

R2 is halogen, hydrogen or methyl

R3 is halogen, hydrogen or methyl

R4: halogen, hydrogen or methyl

R5 is halogen, hydrogen or methyl

R6 is hydrogen, methyl or ethyl

A is O or N

R8 is (CH)ₙ wherein n=1, 2 or 3

R7 is H or a linear alkane (alkane is 1 to 8) or a substituted linear alkane wherein the substituent can be on any place of the linear alkane with a length of 1 to 3 carbons or wherein R7 is a substituted or non-substituted aromatic group wherein the molecular weight of R7 is lower than 250 Dalton for inducing abiotic stress tolerance in plants.

According to the disclosure, the following generic terms are generally used with the following meanings:

Halogen means fluorine, chlorine, bromine or iodine;

Any alkyl group can be linear or branched;

Any of the compounds, according to the disclosure, can exist as one or more stereoisomers depending on the number of stereogenic centers (as defined by the IUPAC rules) in the compound. The disclosure, thus, relates equally to all the stereoisomers, and to the mixtures of all the possible stereoisomers, in all proportions. Typically, one of the stereoisomers has enhanced biological activity compared to the other possibilities. The stereoisomers can be separated according to the methods that are known per se by one skilled in the art. Similarly, where there are disubstituted alkenes, these may be present in E or Z form or as mixtures of both in any proportion. Furthermore, it should be appreciated that all tautomeric forms (single tautomer or mixtures thereof), racemic mixtures and single isomers of compounds of formula (I) are included within the scope of the disclosure.

The disclosure also includes salts of the compounds of formula (I) may form with amines (for example, ammonia, dimethylamine and triethylamine), alkali metal and alkaline earth metal bases or quaternary ammonium bases. Among the alkali metal and alkaline earth metal hydroxides, oxides, alkoxides and hydrogen carbonates and carbonates used as salt formers, emphasis is to be given to the hydroxides, alkoxides, oxides and carbonates of lithium, sodium, potassium, magnesium and calcium. The corresponding trimethylsulfonium salt may also be used.

In a particular embodiment the disclosure provides a compound selected from the list consisting of:

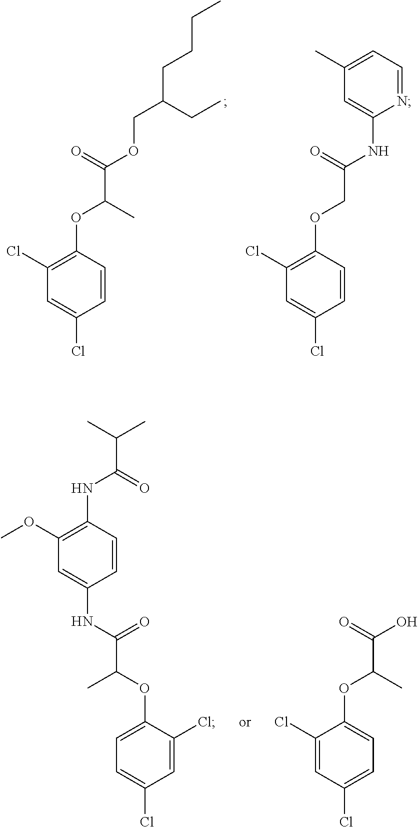 [SMILES: CCCCC(CC)COC(=O)C(C)Oc1ccc(Cl)cc1Cl ; Cc1ccnc(NC(=O)COc2ccc(Cl)cc2Cl)c1 ; COc1cc(NC(=O)C(C)Oc2ccc(Cl)cc2Cl)ccc1NC(=O)C(C)C ; CC(Oc1ccc(Cl)cc1Cl)C(=O)O]

In yet another embodiment, the disclosure provides an agrochemical formulation comprising the previous compounds or the compounds of formula (I) for inducing abiotic stress tolerance in plants.

In a particular embodiment the abiotic stress tolerance in plants is salt tolerance or drought tolerance.

The term “plants” generally comprises all plants of economic importance and/or men-grown plants. They are preferably selected from agricultural, silvicultural and ornamental plants, more preferably agricultural plants and silvicultural plants, most preferably agricultural plants. The term “plant (or plants)” is a synonym of the term “crop,” which is to be understood as a plant of economic importance and/or a men-grown plant. The term “plant,” as used herein, includes all parts of a plant such as germinating seeds, emerging seedlings, herbaceous vegetation as well as established woody plants in-eluding all belowground portions (such as the roots) and aboveground portions.

The plants to be treated are selected from the group consisting of agricultural, silvicultural, ornamental and horticultural plants, each in its natural or genetically modified form, preferably from agricultural plants.

In a preferred embodiment, the plant to be treated, according to the method of the disclosure, is an agricultural plant. “Agricultural plants” are plants of which a part or all is harvested or cultivated on a commercial scale or which serve as an important source of feed, food, fibers (e.g., cotton, linen), combustibles (e.g., wood, bioethanol, biodiesel, biomass) or other chemical compounds. Agricultural plants also include vegetables. Thus, the term agricultural plants include cereals, e.g., wheat, rye, barley, triticale, oats, sorghum or rice; beet, e.g., sugar beet or fodder beet; leguminous plants, such as lentils, peas, alfalfa or soybeans; oil plants, such as rape, oil-seed rape, canola, juncea (Brassica juncea), linseed, mustard, olives, sunflowers, cocoa beans, castor oil plants, oil palms, ground nuts or soybeans; cucurbits, such as squashes, cucumber or melons; fiber plants, such as cotton, flax, hemp or jute; vegetables, such as cucumbers, spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; corn; tobacco; nuts; coffee; tea; vines (table grapes and grape juice grape vines); hop; turf and natural rubber plants.

In a preferred embodiment, the plant to be treated is selected from the group consisting of soybean, sunflower, corn, cotton, canola, sugar cane, sugar beet, pome fruit, barley, oats, sorghum, rice and wheat.

In one embodiment, the plant to be treated, according to the method of the disclosure, is a horticultural plant. The term “horticultural plants” are to be understood as plants which are commonly used in horticulture, e.g., the cultivation of ornamentals, vegetables and/or fruits. Examples for ornamentals are turf, geranium, pelargonia, petunia, begonia and fuchsia. Examples for vegetables are potatoes, tomatoes, peppers, cucurbits, cucumbers, melons, watermelons, garlic, onions, carrots, cabbage, beans, peas and lettuce and more preferably from tomatoes, onions, peas and lettuce. Examples for fruits are apples, pears, cherries, strawberry, citrus, peaches, apricots and blueberries.

In one embodiment, the plant to be treated, according to the method of the disclosure, is an ornamental plant. “Ornamental plants” are plants which are commonly used in gardening, e.g., in parks, gardens and on balconies. Examples are turf, geranium, pelargonia, petunia, begonia and fuchsia.

In one embodiment, the plant to be treated, according to the method of the disclosure, is a silvicultural plant. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec, fir and spruce, eucalyptus, tropical trees like teak, rubber tree, oil palm, willow (Salix), in particular Salix spec, poplar (cottonwood), in particular Populus spec, beech, in particular Fagus spec, birch, oil palm and oak.

The term “plants” also includes plants which have been modified by breeding, mutagenesis or genetic engineering (transgenic and non-transgenic plants). Genetically modified plants are plants, which genetic material has been modified by the use of recombinant DNA techniques in a way that it cannot readily be obtained by cross breeding under natural circumstances, mutations or natural recombination. Typically, one or more genes have been integrated into the genetic material of a genetically modified plant in order to improve certain properties of the plant. Such genetic modifications also include, but are not limited to, targeted post-translational modification of protein(s), oligo- or polypeptides, e.g., by glycosylation or polymer additions such as prenylated, acetylated or farnesylated moieties.

Plants as well as the propagation material of the plants, which can be treated with the agrochemical formulations comprising the compounds of formula (I) include all modified non-transgenic plants or transgenic plants, e.g., crops, which tolerate the action of herbicides or fungicides or insecticides owing to breeding, including genetic engineering methods, or plants which have modified characteristics in comparison with existing plants, which can be generated, for example, by traditional breeding methods and/or the generation of mutants, or by recombinant procedures.

For example, agrochemical formulations comprising the compounds of formula (I), according to the disclosure, can be applied (as seed treatment, foliar spray treatment, in-furrow application or by any other means) also to plants which have been modified by breeding, mutagenesis or genetic engineering including, but not limiting to, agricultural biotech products on the market or in development (cf. on the World Wide Web at bio.org/speeches/pubs/er/agri_products.asp).

Plants that have been modified by breeding, mutagenesis or genetic engineering, e.g., have been rendered tolerant to applications of specific classes of herbicides.

Furthermore, plants are also covered that are generated by the use of recombinant DNA techniques capable to synthesize one or more insecticidal proteins, especially those known from the bacterial genus Bacillus, particularly from Bacillus thuringiensis.

Furthermore, plants are also covered that are generated by the use of recombinant DNA techniques capable to synthesize one or more proteins to increase the resistance or tolerance of those plants to bacterial, viral or fungal pathogens. Furthermore, plants are also covered that are by the use of recombinant DNA techniques capable to synthesize one or more proteins to increase the productivity (e.g., biomass production, grain yield, starch content, oil content or protein content), tolerance to drought, salinity or other growth-limiting environmental factors or tolerance to pests and fungal, bacterial or viral pathogens of those plants.

Furthermore, plants are also covered that contain, by the use of recombinant DNA techniques, a modified amount of substances of content or new substances of content, specifically to improve human or animal nutrition, e.g., oil crops that produce health-promoting long-chain omega-3 fatty acids or unsaturated omega-9 fatty acids.

Furthermore, plants are also covered that contain, by the use of recombinant DNA techniques, a modified amount of substances of content or new substances of content, specifically to improve raw material production, e.g., potatoes that produce increased amounts of amylopectin.

The term “plant propagation material” is to be understood to denote all the generative parts of the plant such as seeds and vegetative plant material such as cuttings and tubers (e.g., potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained. The term “propagules” or “plant propagules” is to be understood to denote any structure with the capacity to give rise to a new plant, e.g., a seed, a spore, or a part of the vegetative body capable of independent growth, if detached from the parent. In a preferred embodiment, the term “propagules” or “plant propagules” denotes for seed.

In a particular embodiment, the compound of formula (I) or an agrochemical formulation comprising a compound of formula (I) are used for increasing the yield of plants.

According to the disclosure, “increased yield” of a plant, in particular of an agricultural, silvicultural and/or horticultural plant means that the yield of a product of the respective plant is increased by a measurable amount over the yield of the same product of the plant produced under the same conditions, but without the application of the agrochemical formulation of the disclosure.

Increased yield can be characterized, among others, by the following improved properties of the plant: increased plant weight, increased biomass such as higher overall fresh weight (FW) or higher total dry matter (TDM), increased number of flowers per plant, higher grain and/or fruit yield, more tillers or side shoots (branches), larger leaves, increased shoot growth, increased protein content, increased oil content, increased starch content, increased pigment content, increased chlorophyll content (chlorophyll content has a positive correlation with the plant's photosynthesis rate and accordingly, the higher the chlorophyll content the higher the yield of a plant). In a preferred embodiment, the term “yield” refers to fruits in the proper sense, vegetables, nuts, grains and seeds. “Grain” and “fruit” are to be understood as any plant product which is further utilized after harvesting, e.g., fruits in the proper sense, vegetables, nuts, grains, seeds, wood (e.g., in the case of silviculture plants), flowers (e.g., in the case of gardening plants, ornamentals), etc., that is anything of economic value that is produced by the plant.

According to the disclosure, the yield is increased by at least 5%, preferable by 5% to 10%, more preferable by 10% to 20%, or even 20% to 30% compared to the untreated control plants. In general, the yield increase may even be higher.

In yet another particular embodiment, the compound of formula (I) or an agrochemical formulation comprising a compound of formula (I) are used for increasing the vigor of plants.

Another indicator for the condition of the plant is the plant vigor. The plant vigor becomes manifest in several aspects such as the general visual appearance.

Improved plant vigor can be characterized, among others, by the following improved properties of the plant: improved vitality of the plant, improved plant growth, improved plant development, improved visual appearance, improved plant stand (less plant verse/lodging), improved emergence, enhanced root growth and/or more developed root system, enhanced nodulation, in particular rhizobial nodulation, bigger leaf blade, bigger size, increased plant height, increased tiller number, increased number of side shoots, increased number of flowers per plant, increased shoot growth, increased root growth (extensive root system), enhanced photosynthetic activity (e.g., based on increased stomatal conductance and/or increased CO₂ assimilation rate), enhanced pigment content, earlier flowering, earlier fruiting, earlier and improved germination, earlier grain maturity, less non-productive tillers, less dead basal leaves, less input needed (such as fertilizers or water), greener leaves, complete maturation under shortened vegetation periods, less fertilizers needed, less seeds needed, easier harvesting, faster and more uniform ripening, longer shelf-life, longer panicles, delay of senescence, stronger and/or more productive tillers, better extractability of ingredients, improved quality of seeds (for being seeded in the following seasons for seed production), reduced production of ethylene and/or the inhibition of its reception by the plant.

According to the present disclosure, the plant vigor is increased by at least 5%, preferable by 5% to 10%, more preferable by 10% to 20%, or even 20% to 30% compared to the untreated control plants. In general, the plant vigor increase may even be higher.

Negative factors caused by abiotic stress are also well known and can often be observed as reduced plant vigor (see above), for example: dotted leaves, “burned leaves,” reduced growth, less flowers, less biomass, less crop yields, reduced nutritional value of the crops, later crop maturity, to give just a few examples. Abiotic stress can be caused, for example, by extremes in temperature such as heat or cold (heat stress/cold stress) strong variations in temperature, temperatures unusual for the specific season, drought (drought stress), extreme wetness, high salinity (salt stress), radiation (for example, by increased UV radiation due to the decreasing ozone layer), increased ozone levels (ozone stress).

As a result of abiotic stress factors, the quantity and the quality of the stressed plants, their crops and fruits decrease. As far as quality is concerned, reproductive development is usually severely affected with consequences on the crops, which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

According to the disclosure, the plant's tolerance or resistance to abiotic stress is increased by at least 5%, preferable by 5% to 10%, more preferable by 10% to 20%, or even 20% to 30% compared to the untreated control plants.

Advantageous properties, obtained especially from treated seeds, are, e.g., improved germination and field establishment, better vigor and/or a more homogenous field establishment.

As pointed out above, the above identified indicators for the health condition of a plant may be interdependent and may result from each other. For example, an increased resistance to abiotic stress may lead to a better plant vigor, e.g., to better and bigger crops, and, thus, to an increased yield. Inversely, a more developed root system may result in an increased resistance to biotic and/or abiotic stress. However, these interdependencies and interactions are neither all known nor fully understood and, therefore, the different indicators are described separately.

In another embodiment of the disclosure, the agrochemical formulations comprising the compounds of formula (I) are used for increasing the total dry matter (TDM) of a plant.

In another embodiment of the disclosure, the agrochemical formulations comprising the compounds of formula (I) are used for increasing the chlorophyll content of a plant.

In another embodiment, the agrochemical formulations comprising the compounds of formula (I) increase the vigor of a plant or its products.

In another embodiment, the agrochemical formulations comprising the compounds of formula (I) increase the quality of a plant or its products.

In yet another embodiment, the agrochemical formulations comprising the compounds of formula (I) increase the tolerance and/or resistance of a plant or its products against abiotic stress.

In a preferred embodiment, the agrochemical formulations comprising the compounds of formula (I) increases the tolerance and/or resistance of a plant or its products against drought stress.

In another preferred embodiment, the agrochemical formulations comprising the compounds of formula (I) increases the tolerance and/or resistance of a plant or its products against cold stress.

In yet another preferred embodiment, the agrochemical formulations comprising the compounds of formula (I) increase the tolerance and/or resistance of a plant or its products against heat stress.

The agrochemical formulations comprising the compounds of formula (I) are employed by treating the plant, plant propagation material (preferably seed), soil, area, material or environment in which a plant is growing or may grow with an effective amount of the active compounds.

In one embodiment of the disclosure, a mixture for increasing the health of a plant is applied at a growth stage (GS) between GS 00 and GS 73 BBCH of the treated plant.

In a preferred embodiment of the disclosure, an agrochemical formulations comprising the compounds of formula (I) for increasing the health of a plant is applied at a growth stage (GS) between GS 00 and GS 71 BBCH of the treated plant.

In an even more preferred embodiment of the disclosure, an agrochemical formulation comprising the compounds of formula (I) for increasing the health of a plant is applied at a growth stage (GS) between GS 12 and GS 49 BBCH of the treated plant.

In a most preferred embodiment of the disclosure, an agrochemical formulation comprising the compounds of formula (I) for increasing the health of a plant is applied at a growth stage (GS) between GS 12 and GS 16 BBCH of the treated plant.

The term “growth stage” (GS) refers to the extended BBCH-scale, which is a system for a uniform coding of phenologically similar growth stages of all mono- and dicotyledonous plant species in which the entire developmental cycle of the plant is subdivided into clearly recognizable and distinguishable longer-lasting developmental phases. The BBCH-scale uses a decimal code system, which is divided into principal and secondary growth stages. The abbreviation BBCH derives from the Federal Biological Research Center for Agriculture and Forestry (Germany), the Bundessortenamt (Germany) and the chemical industry.

When preparing the agrochemical formulations comprising the compounds of formula (I), it is preferred to employ the pure active compounds, to which further active compounds against pests, such as insecticides, herbicides, fungicides or else herbicidal or growth-regulating active compounds or fertilizers can be added as further active components according to need.

As stated above, the agrochemical formulations comprising the compounds of formula (I) are used in “effective amounts.” This means that they are used in a quantity which allows to obtain the desired effect which is a synergistic increase of the health of a plant but which does not give rise to any phytotoxic symptom on the treated plant.

For use according to the disclosure, the agrochemical formulations comprising the compounds of formula (I) can be converted into the customary formulations, for example, solutions, emulsions, suspensions, dusts, powders, pastes and granules. The use form depends on the particular intended purpose; in each case, it should ensure a fine and even distribution of the agrochemical formulations comprising the compounds of formula (I), according to the disclosure. The formulations are prepared in a known manner to the person skilled in the art.

The agrochemical formulations may also comprise auxiliaries which are customary in agrochemical formulations. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g., for seed treatment formulations).

Suitable solvents are water, organic solvents such as mineral oil fractions of medium to high boiling point, such as kerosene or diesel oil, furthermore, coal tar oils and oils of vegetable or animal origin, aliphatic, cyclic and aromatic hydrocarbons, e.g., toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g., amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsulfonic acid, phenolsulfonic acid, naphthalenesulfonic acid, dibutylnaphthalene-sulfonic acid and fatty acids, alkylsulfonates, alkyl-arylsulfonates, alkyl sulfates, laurylether sulfates, fatty alcohol sulfates, and sulfated hexa-, hepta- and octadecanolates, sulfated fatty alcohol glycol ethers, furthermore, condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearyl-phenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquid and proteins, denatured proteins, polysaccharides (e.g., methylcellulose), hydrophobically modified starches, polyvinyl alcohols, polycarboxylates types, polyalkoxylates, polyvinylamines, polyvinylpyrrolidone and the copolymers thereof. Examples for thickeners (i.e., compounds that impart a modified flowability to formulations, i.e., high viscosity under static conditions and low viscosity during agitation) are polysaccharides and organic and anorganic clays such as Xanthan gum.

Bactericides may be added for preservation and stabilization of the formulation. Examples for suitable bactericides are those based on dichlorophene and benzylalcohol hemi formal (PROXEL® from ICI or ACTICIDE® RS from Thor Chemie and KATHON® MK from Rohm & Haas) and isothiazolinone derivatives such as alkyl isothiazolinones and benzisothiazolinones (ACTICIDE® M BS from Thor Chemie). Examples for suitable anti-freezing agents are ethylene glycol, propylene glycol, urea and glycerin. Examples for anti-foaming agents are silicone emulsions (such as, e.g., SILIKON® SRE, Wacker, Germany or RHODORSIL®, Rhodia, France), long chain alcohols, fatty acids, salts of fatty acids, fluoroorganic compounds and agrochemical formulations comprising the compounds of formula (I) thereof.

Suitable colorants are pigments of low water solubility and water-soluble dyes.

Examples for tackifiers or binders are polyvinylpyrrolidones, polyvinylacetates, polyvinyl alcohols and cellulose ethers (TYLOSE®, Shin-Etsu, Japan).

Granules, e.g., coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

The agrochemical formulations generally comprise between 0.01% and 95%, preferably between 0.1% and 90%, most preferably between 0.5% and 90%, by weight of active substances. The compounds of the agrochemical formulations comprising the compounds of formula (I) are employed in a purity of from 90% to 100%, preferably from 95% to 100% (according to their NMR spectrum).

The compounds of the agrochemical formulations comprising the compounds of formula (I) can be used as such or in the form of their agricultural compositions, e.g., in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the compounds present in the agrochemical formulations comprising the compounds of formula (I).

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active sub-stance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001% to 10%, preferably from 0.001% to 1% by weight of compounds of the agrochemical formulations comprising the compounds of formula (I).

The compounds of the agrochemical formulations comprising the compounds of formula (I) may also be used successfully in the ultra-low-volume process (ULV), it being possible to apply compositions comprising over 95% by weight of active substance, or even to apply the active substance without additives.

Various types of oils, wetters, adjuvants, herbicides, fungicides, other pesticides, or bactericides may be added to the active compounds, if appropriate, not until immediately prior to use (tank mix). These agents can be admixed with the compounds of the agrochemical formulations comprising the compounds of formula (I) in a weight ratio of 1:100 to 100:1, preferably 1:10 to 10:1.

Compositions of this disclosure may also contain fertilizers such as ammonium nitrate, urea, potash, and superphosphate, phytotoxicants and plant growth regulators and safeners. These may be used sequentially or in combination with the above-described compositions, if appropriate, also added only immediately prior to use (tank mix). For example, the plant(s) may be sprayed with a composition of this disclosure either before or after being treated with the fertilizers.

In the agrochemical formulations comprising the compounds of formula (I), the weight ratio of the compounds generally depend from the properties of the compounds of the agrochemical formulations comprising the compounds of formula (I).

The compounds of the agrochemical formulations comprising the compounds of formula (I) can be used individually or already partially or completely mixed with one another to prepare the composition, according to the disclosure. It is also possible for them to be packaged and used further as combination composition such as a kit of parts.

The user applies the composition, according to the disclosure, usually from a pre-dosage device, a knapsack sprayer, a spray tank or a spray plane. Here, the agrochemical composition is made up with water and/or buffer to the desired application concentration, it being possible, if appropriate, to add further auxiliaries, and the ready-to-use spray liquid or the agrochemical composition, according to the disclosure, is thus obtained. Usually, 50 to 500 liters of the ready-to-use spray liquid are applied per hectare of agricultural useful area, preferably 50 liters to 400 liters.

In a particular embodiment, the absolute amount of the active compounds, represented by formula (I), is used in a range between 1 mg/liter-100 mg/liter, particularly in a range between 1 mg/l-20 mg/l, particularly in a range between 1 mg/l-25 mg/l, particularly in a range between 2 mg/l-200 mg/l, particularly between 2 mg/l-100 mg/l, particularly between 2 mg/l-50 mg/l, particularly between 2 mg/l-25 mg/l, particularly between 4 mg/l-40 mg/l, particularly between 4 mg/l-20 mg/l, particularly between 4 mg/l-16 mg/l, particularly between 4 mg/l-12 mg/l.

According to one embodiment, individual compounds of the agrochemical formulations comprising the compounds of formula (I) formulated as composition (or formulation) such as parts of a kit or parts of the inventive mixture may be mixed by the user himself in a spray tank and further auxiliaries may be added, if appropriate (tank mix).

“Agrochemical,” as used herein, means any active substance that may be used in the agrochemical industry (including agriculture, horticulture, floriculture and home and garden uses, but also products intended for non-crop related uses such as public health/pest control operator uses to control undesirable insects and rodents, household uses, such as household fungicides and insecticides and agents, for protecting plants or parts of plants, crops, bulbs, tubers, fruits (e.g., from harmful organisms, diseases or pests); for controlling, preferably promoting or increasing, the growth of plants; and/or for promoting the yield of plants, crops or the parts of plants that are harvested (e.g., its fruits, flowers, seeds, etc.).

An “agrochemical composition,” as used herein, means a composition for agrochemical use, as herein defined, comprising at least one active substance of a compound of formula (I), optionally with one or more additives favoring optimal dispersion, atomization, deposition, leaf wetting, distribution, retention and/or uptake of agrochemicals. As a non-limiting example such additives are diluents, solvents, adjuvants, surfactants, wetting agents, spreading agents, oils, stickers, thickeners, penetrants, buffering agents, acidifiers, anti-settling agents, anti-freeze agents, photo-protectors, defoaming agents, biocides and/or drift control agents.

A “carrier,” as used herein, means any solid, semi-solid or liquid carrier in or on(to) which an active substance can be suitably incorporated, included, immobilized, adsorbed, absorbed, bound, encapsulated, embedded, attached, or comprised. Non-limiting examples of such carriers include nanocapsules, microcapsules, nanospheres, microspheres, nanoparticles, microparticles, liposomes, vesicles, beads, a gel, weak ionic resin particles, liposomes, cochleate delivery vehicles, small granules, granulates, nano-tubes, bucky-balls, water droplets that are part of an water-in-oil emulsion, oil droplets that are part of an oil-in-water emulsion, organic materials such as cork, wood or other plant-derived materials (e.g., in the form of seed shells, wood chips, pulp, spheres, beads, sheets or any other suitable form), paper or cardboard, inorganic materials such as talc, clay, microcrystalline cellulose, silica, alumina, silicates and zeolites, or even microbial cells (such as yeast cells) or suitable fractions or fragments thereof.

The terms “effective amount,” “effective dose” and “effective amount,” as used herein, mean the amount needed to achieve the desired result or results. More exemplary information about amounts, ways of application and suitable ratios to be used is given below. The skilled artisan is well aware of the fact that such an amount can vary in a broad range and is dependent on various factors such as the treated cultivated plant as well as the climatic and soil conditions.

As used herein, the terms “determining,” “measuring,” “assessing,” “monitoring” and “assaying” are used interchangeably and include both quantitative and qualitative determinations.

It is understood that the agrochemical composition is stable, both during storage and during utilization, meaning that the integrity of the agrochemical composition is maintained under storage and/or utilization conditions of the agrochemical composition, which may include elevated temperatures, freeze-thaw cycles, changes in pH or in ionic strength, UV-irradiation, presence of harmful chemicals and the like. More preferably, the compounds of formula (I), as herein described, remain stable in the agrochemical composition, meaning that the integrity and the activity of the compounds are maintained under storage and/or utilization conditions of the agrochemical composition, which may include elevated temperatures, freeze-thaw cycles, changes in pH or in ionic strength, UV-irradiation, presence of harmful chemicals and the like. Most preferably, the compounds of formula (I) remain stable in the agrochemical composition when the agrochemical composition is stored at ambient temperature for a period of two years or when the agrochemical composition is stored at 54° C. for a period of two weeks. Preferably, the agrochemical composition of the disclosure retains at least about 70% activity, more preferably at least about 70% to 80% activity, most preferably about 80% to 90% activity or more. Examples of suitable carriers include, but are not limited to, alginates, gums, starch, β-cyclodextrins, celluloses, polyurea, polyurethane, polyester, or clay.

The agrochemical composition may occur in any type of formulation, preferred formulations are powders, wettable powders, wettable granules, water dispersible granules, emulsions, emulsifiable concentrates, dusts, suspensions, suspension concentrates, suspoemulsions, capsule suspensions, aqueous dispersions, oil dispersions, aerosols, pastes, foams, slurries or flowable concentrates.

In yet another embodiment, the disclosure provides the use of the agrochemical compositions of the disclosure for enhancing abiotic stress tolerance in plants.

According to the method of the disclosure, the agrochemical composition, according to the disclosure, can be applied once to a crop, or it can be applied two or more times after each other with an interval between every two applications. According to the method of the disclosure, the agrochemical composition, according to the disclosure, can be applied alone or in mixture with other materials, preferably other agrochemical compositions, to the crop; alternatively, the agrochemical composition, according to the disclosure, can be applied separately to the crop with other materials, preferably other agrochemical compositions, applied at different times to the same crop.

In yet another embodiment, the disclosure provides a method for the manufacture (“or the production of,” which is equivalent wording) an agrochemical composition, according to the disclosure, comprising formulating a molecule of formula (I), as defined herein before, together with at least one customary agrochemical auxiliary agent. Suitable manufacturing methods are known in the art and include, but are not limited to, high or low shear mixing, wet or dry milling, drip-casting, encapsulating, emulsifying, coating, encrusting, pilling, extrusion granulation, fluid bed granulation, co-extrusion, spray drying, spray chilling, atomization, addition or condensation polymerization, interfacial polymerization, in situ polymerization, coacervation, spray encapsulation, cooling melted dispersions, solvent evaporation, phase separation, solvent extraction, sol-gel polymerization, fluid bed coating, pan coating, melting, passive or active absorption or adsorption.

Customary agrochemical auxiliary agents are well known in the art and include, but are not limited to, aqueous or organic solvents, buffering agents, acidifiers, surfactants, wetting agents, spreading agents, tackifiers, stickers, carriers, fillers, thickeners, emulsifiers, dispersants, sequestering agents, anti-settling agents, coalescing agents, rheology modifiers, defoaming agents, photo-protectors, anti-freeze agents, biocides, penetrants, mineral or vegetable oils, pigments and drift control agents or any suitable combination thereof.

The following non-limiting examples describe methods and means, according to the disclosure. Unless stated otherwise in the examples, all techniques are carried out according to protocols standard in the art. The following examples are included to illustrate embodiments of the disclosure. Those of skill in the art should, in light of the present disclosure, appreciate that many changes can be made in the specific embodiment, which are disclosed and still obtain a like or similar result without departing from the concept, spirit and scope of the disclosure. More specifically, it will be apparent that certain agents, which are both chemically and physiologically related, may be substituted for the agents described herein while the same or similar results would be achieved. All such similar substitutes and modifications apparent to those skilled in the art are deemed to be within the spirit, scope and concept of the disclosure as defined by the appended claims.

### Examples and Materials and Methods

### 1. High-Throughput Screening Assay for Chemicals that can Induce Tolerance to Photorespiratory Stress in Plants

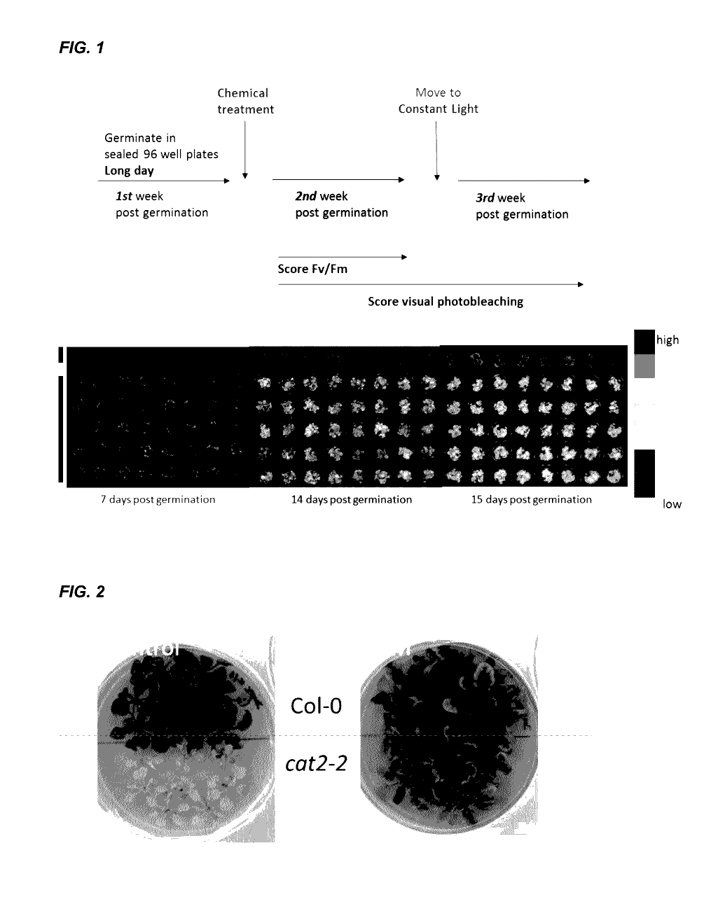

Photorespiration (Rp) is a major source of detrimental effects and yield losses in crop plants. Catalase is one of the crucial proteins in the Rp process since it provides the dissipation sink of photosynthetic excitation overload in the role of Rp as a photo-protective mechanism. Secondly, and as part of the same process, catalase provides effective defense against excessive hydrogen peroxide levels, without requiring additional energy from other sources. Catalase knock-out mutant plants thus provide an excellent tool to study the process of Rp (see Vandenabeele S et al., (2003) PNAS 100, 26, 16113-16118). In the disclosure, we developed a high-throughput screening assay by using a catalase-2 deficient plant. A schematic overview of this high-throughput screening assay is depicted in FIG. 1 and is explained herein further. Arabidopsis thaliana catalase 2-knock out plants were submerged in liquid culture using 96 well plates and as such by default exposed to gas restricting conditions due to low diffusion rates of carbon dioxide and oxygen in water. In the art it is known that in the submergence response in plants, Rp is deemed to be the main player (see Mommer L. et al., (2005) Plant Physiol. 139(1): 497-508). We applied this system to screen for chemicals that can overcome photorespiratory damage in catalase-2 deficient A. thaliana plants. As a chemical library we applied the 10,000 compound collection of the DiverSet 1 from ChemBridge. Before embarking on the screen a series of tests were performed with the aim of establishing a fast induction of cell death and reduction in Fv/Fm from healthy (grown in liquid medium) catalase-2 A. thaliana mutants. Fv/Fm is a parameter widely used to indicate the maximum quantum efficiency of Photosystem II. This parameter is widely considered to be a sensitive indication of plant photosynthetic performance with healthy samples typically achieving a maximum Fv/Fm value of approx. 0.85. Values lower than this will be observed if a sample has been exposed to abiotic stress, which has reduced the capacity for photochemical quenching of energy within Photosystem II. Fv/Fm is presented as a ratio of variable fluorescence (Fv) over the maximum fluorescence value (Fm). During the optimization of the mutant screen we established that long term (several days) restriction of gas exchange combined with transferring long day plants to constant light conditions provoked a stable and predictive induction of cell death and early detectability of a reduction in Fv/Fm.

The submergence response system was mimicked in the miniature 96-well plate format and showed that growing cat 2-1 mutants in medium supplemented with 0.2% sucrose, resulted in the lowest variation between individual wells and that growing plants in the liquid medium (on parafilm sealed plates) was sufficient to provoke the reduced gas exchange effect seen in the catalase-2 mutants. Together with a transfer from the long day growing conditions to constant light, both predictive induction of cell death and early detectability of a reduction in Fv/Fm could be achieved.

### 2. Identification of Compounds Able to Rescue Photorespiratory Cell Death

During the primary screen, 10,000 different chemical compounds were added to separate wells and in each of the wells healthy looking catalase-2 mutant plantlets were present. On a regular basis Fv/Fm was monitored for all wells, using a Walz Maxi PAM imager. Several days after transfer to constant light the individual wells were visually scored for cell death. Although in the screen we could detect compounds that maintained a high Fv/Fm or reduced cell death separately, we chose to select only those compounds that both maintained a high Fv/Fm and reduced cell death at the same time. We employed subjective scoring, using the PAM and bright field pictures of the 96 well plates, to score the individual wells. Three persons scored independently, and only a consensus of ⅔ scores were maintained as positive hits. In this way we identified 157 hits which were retested in a secondary screen.

In the secondary screen we had a very strong and convincing enrichment in positive hits. Using a more detailed analysis, analyzing the wells every day and introducing the criterion that no pre stress recovery was allowed and only selecting the plants with the least cell death at the end of the stress we finally confirmed 35 hits for further studies.

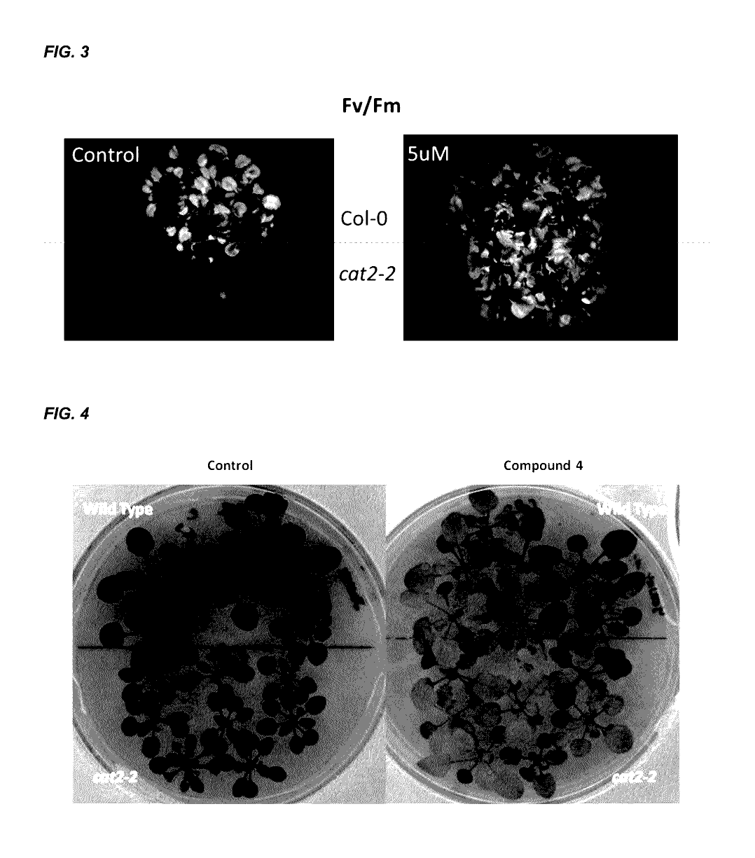

Out of 35 identified hits identified in the screen, we reconfirmed all 35 in the original screening assay, established that 16 out of the 35 were dose responsive and confirmed the activities of 5 of these in agar grown catalase mutants exposed to photorespiratory conditions (Restricted Gas exchange Constant Light; RGCL). Two of the compounds had a markedly stronger dose response than the rest. However, out of these two, only compound 4 had a confirmed effect in the agar assay (see FIGS. 2 and 3). In FIGS. 2 and 3 it can be observed that compound 4 has a pronounced effect at a concentration of 5 μM to overcome cell death of the catalase-2 mutant when grown under high light conditions.

Compound 4 has the following structure:

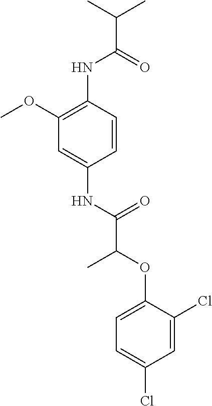 [SMILES: COc1cc(NC(=O)C(C)Oc2ccc(Cl)cc2Cl)ccc1NC(=O)C(C)C]

Importantly, in the agar assay we have strong experimental evidence for Rp being the major stress factor, contributing to the measured effects. Compound 4 outcompeted all of the rest of the 35 compounds in salvaging growth, photosynthetic efficiency and virtually obliterated the cell death caused by the photorespiratory stress.

Aside from these salvaging effects, compound 4 also contributed to increased growth in non-stress conditions, in both wild types and catalase mutants (see FIG. 4).

### 3. Identification and Testing of Variants of Compound 4

In a next step we selected several variants of compound 4 and in particular variants which comprised the following structure:

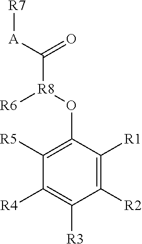

Wherein A being O or N and the R1, R2, R3, R4, R5, R6 and R7 groups are as defined in the claims.

Variant 1 has oxygen (O) in A, while variant 2 has nitrogen (N) in A.

Variant 1 has the following structure:

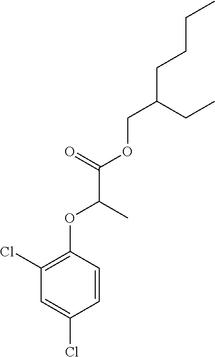 [SMILES: CCCCC(CC)COC(=O)C(C)Oc1ccc(Cl)cc1Cl]

Variant 2 has the following structure:

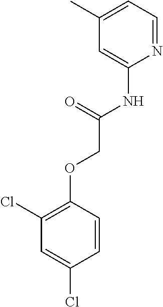 [SMILES: Cc1ccnc(NC(=O)COc2ccc(Cl)cc2Cl)c1]

Both variants 1 and 2 where tested under the same conditions as compound 4.

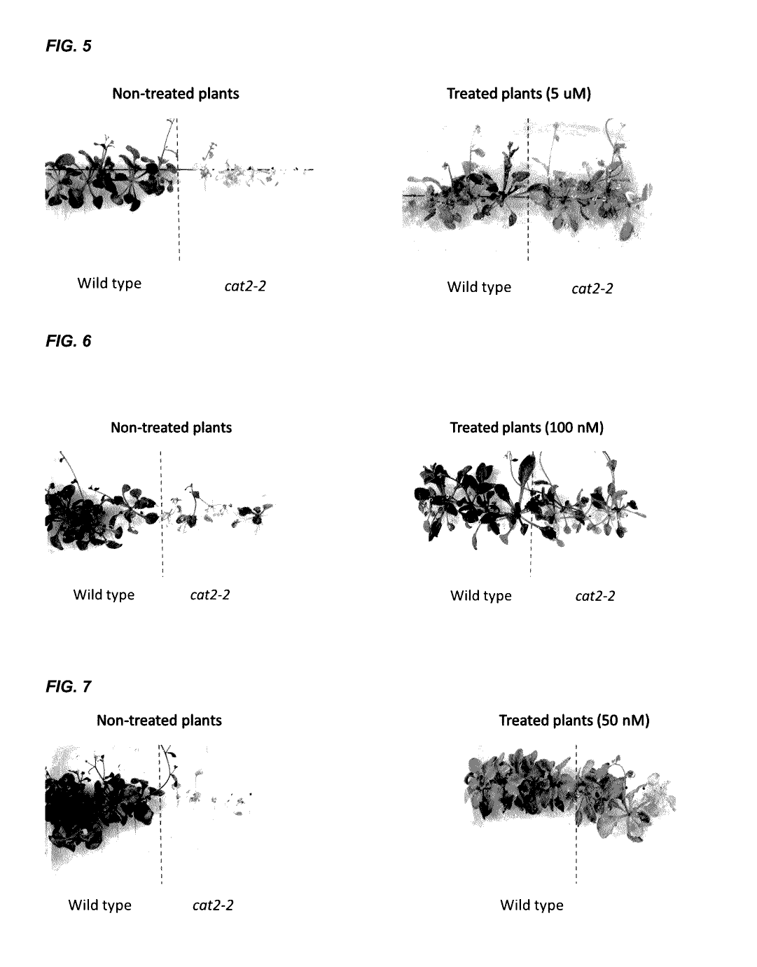

FIG. 5 shows the effect of compound 4 (5 μM) on the rescue of cat2-2 plants. FIG. 6 shows the rescue of cat2-2 plants with variant 1 at a 50-fold lower concentration (100 nM). FIG. 7 shows the effect of variant 2 at a 100-fold lower concentration (50 nM).

### 4. Compound 4 Induces Salt Tolerance

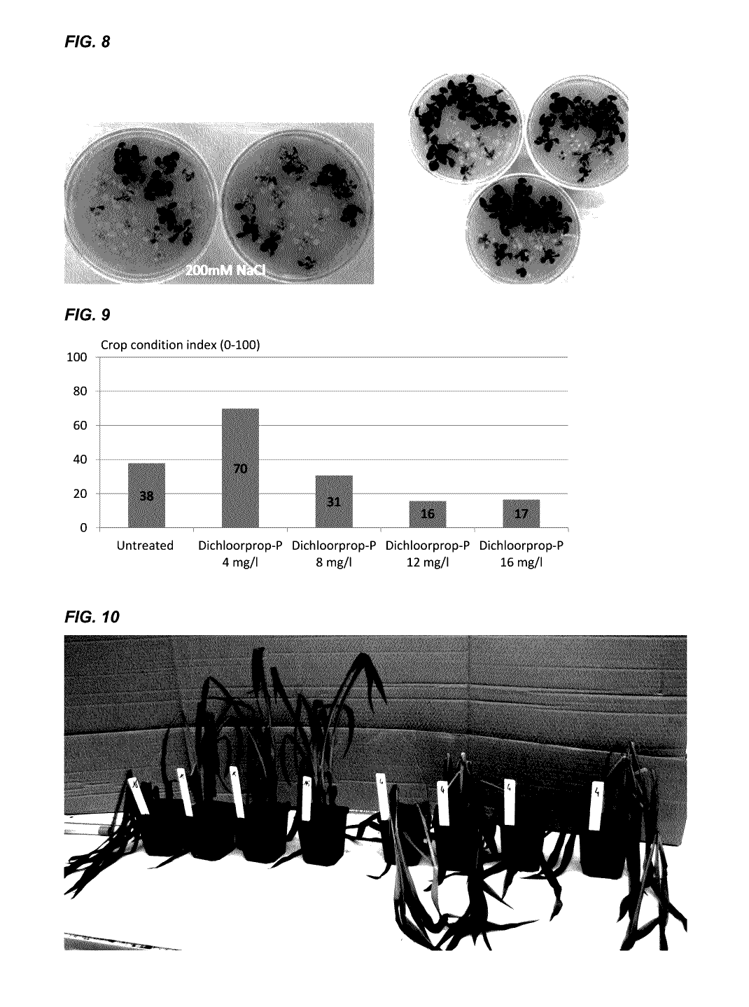

In this experiment wild-type A. thaliana plantlets (Col-0) are subjected to moderate salt stress (200 mM NaCl). In the left panel plantlets are grown without compound 4 while in the right panel plantlets are grown in the presence of 5 μM of compound 4. FIG. 8 clearly shows that 5 μM of compound 4 is able to provide a significance tolerance to 200 mM NaCl.

### 5. Application of Dichloroprop-P Induces Frost Tolerance in Maize

Yet another variant which was tested in the context of the disclosure is dichloroprop-P, its chemical structure shown herein below:

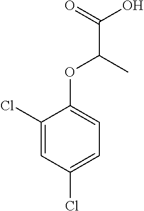

Maize of the variety Maibi was sown in small pots (8×8×8 cm) filled with universal peat at 4 grains per pot. The plants were grown in a non-heated greenhouse until BBCH 13 (3 unfolded leaves). At that stage plants were either or not treated with dichloroprop-P (Duplosan DP, 600 g/l dichloroprop-P, Nufarm UK Limited), using a Birchmeier hand sprayer with an operating pressure of 2 bar. Per object 10 pots were treated. The 10 pots were put in line, 5 cm apart, and were sprayed overhead within 6 seconds. Four different concentrations of dichloroprop-P were applied: 4 mg/l, 8 mg/1, 12 mg/l or 16 mg/l. 24 hours after treatment, the plants were transferred in to a refrigerator that was set at −2° C. for 6 hours. Afterwards the plants were transferred back to the greenhouse. The day after the cold treatment (so 2 days after application of dichloroprop-P) the plants were assessed visually for frost damage. Plants were divided into 3 categories: Good crop condition (=2), only moderate crop condition (=1) or bad crop condition (=0), based on which a crop condition index was calculated, ranging from 0 (bad crop condition) to 100 (good crop condition).

As is apparent from FIGS. 9 and 10, the treatment of maize with dichloroprop-P at a concentration of 4 mg/l resulted in a better crop condition after frost, thus in an increased stress tolerance. At higher concentrations (12 and 16 mg/l) dichloroprop-P had a negative effect on frost tolerance, indicating that the response of plants to dichloroprop-P and the products ability to induce stress tolerance in plants is dose dependent.

### 6. Application of Dichloroprop-P Induces Salt Tolerance in Oilseed Rape

Oilseed rape of the variety Alessio was sown in small pots (8×8×8 cm) filled with universal peat at 4 grains per pot. The plants were grown in a non-heated greenhouse until BBCH 13 (3 unfolded leaves). At that stage the number of plants per pot was reduced to 2, and the plants were either or not treated with dichloroprop-P (Duplosan DP, 600 g/l dichloroprop-P, Nufarm UK Limited), using a Birchmeier hand sprayer with an operating pressure of 2 bar. Per object 8 pots were treated. The 8 pots were put in line, 5 cm apart, and were sprayed overhead within 6 seconds. Two different concentrations of dichloroprop-P were applied: 4 mg/l or 8 mg/l. 24 hours after treatment, the plants were irrigated with salt water, giving 50 ml of water per pot at a concentration of 80 grams of NaCl per liter of water. The following days the plants were assessed visually for salt damage. Plants were divided into 3 categories: high vitality (=2), only moderate vitality (=1) or low vitality (=0), based on which a vitality index was calculated, ranging from 0 (low vitality) to 100 (high vitality).

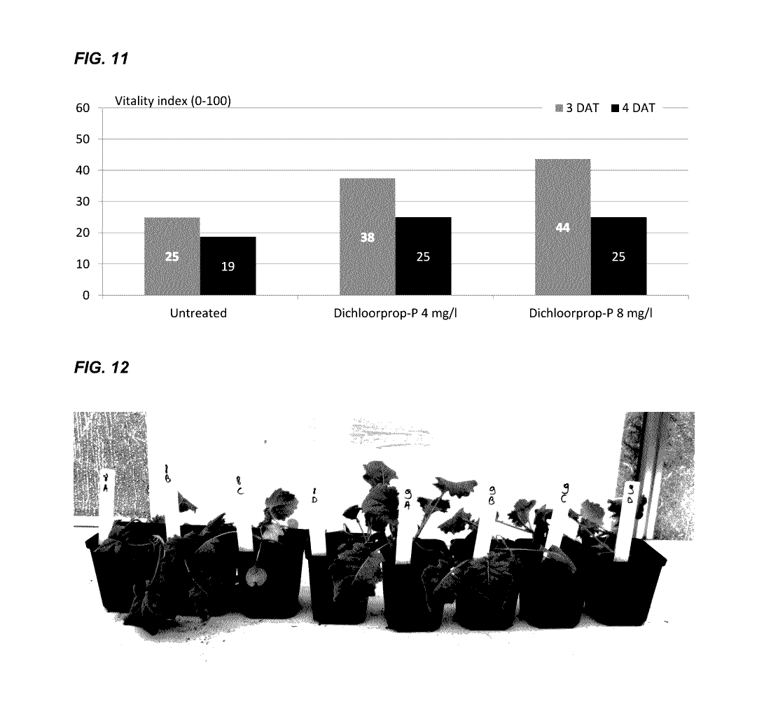

FIGS. 11 and 12 clearly show that treating oilseed rape plants with dichloroprop-P resulted in an increased vitality in salt stress conditions. Treatment with dichloroprop-P at a concentration of 4 and 8 mg/l gave a comparable increase in salt stress tolerance.

### 7. Synthesis Schemes of the Compounds of the Invention

7.1 General Retro Synthesis Scheme

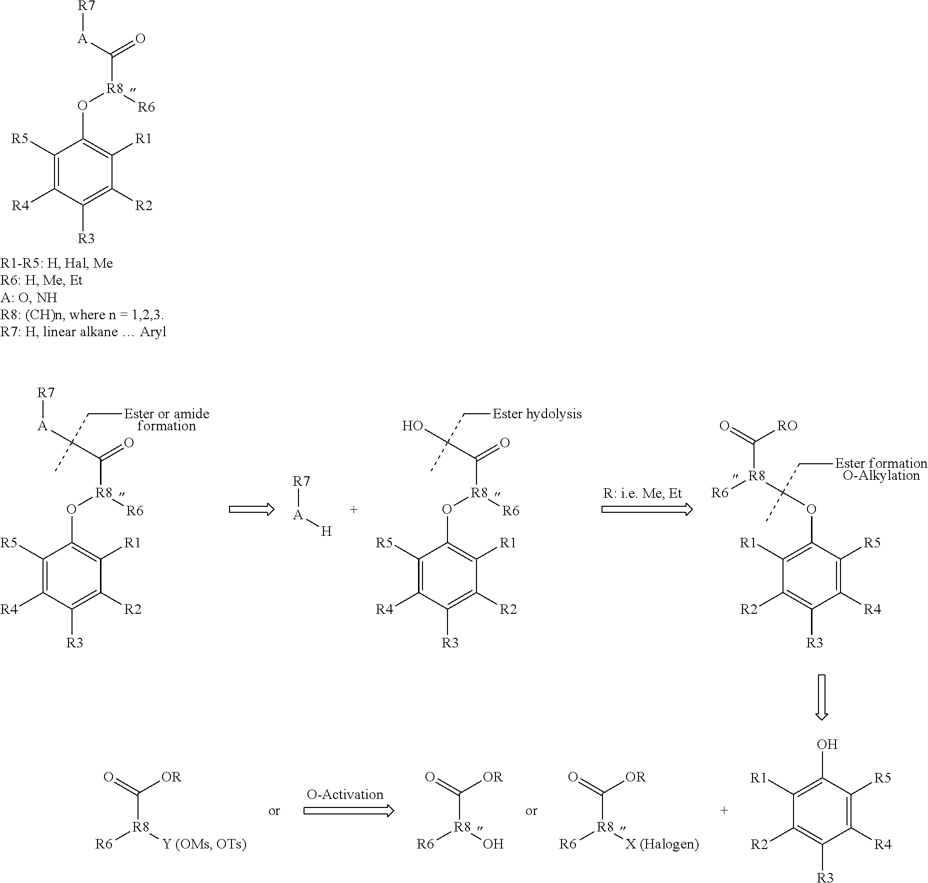

7.2 General Synthesis: O-Alkylation Form Hydroxyesters (Mitsunobu Reaction), O-Alkylation of Haloesters

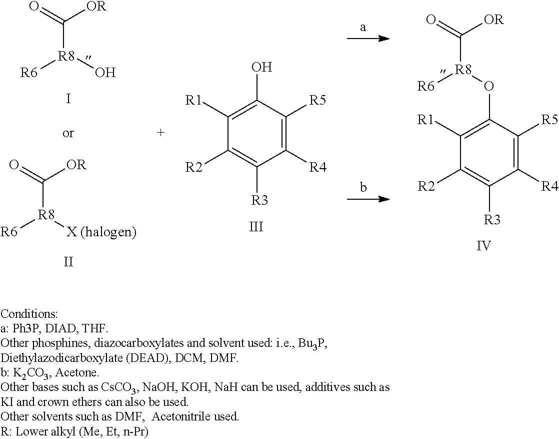

NOTE: When R8/R6/OH: CH(R6)(OH) compounds of formula IV will have inversion of sterochemistry with respect to starting material I and II. The reaction produces an inversion of stereochemistry.

When R8/R6/OH: CH(R6)CH2(OH) and CH(R6)CH2CH2(OH) compounds IV will have the same stereochemistry as I and II.

7.3 General Synthesis: O-Alkylation from Activated Hydroxyesters (Sulfonates)

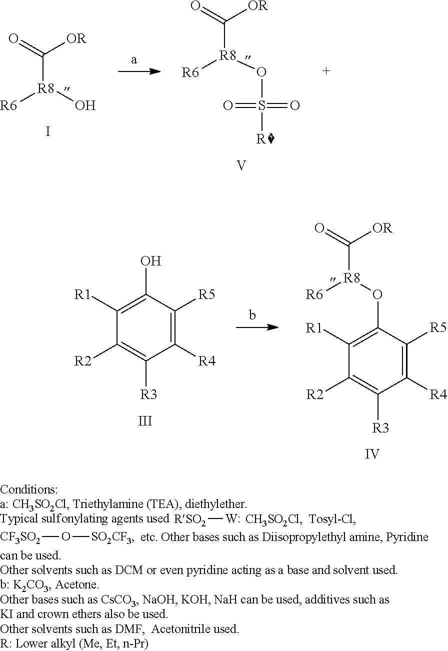

NOTE: When R8/R6/OH: CH(R6)(OH) compounds of formula IV will have an inversion of stereochemistry with respect to sulfonates V. The reaction produces an inversion of stereochemistry. When R8/R6/OH: CH(R6)CH2(OH) and CH(R6)CH2CH2(OH) compounds IV will have the same stereochemistry as V.

7.4 General Synthesis: Ester Hydrolysis (and Carboxamide Formation)

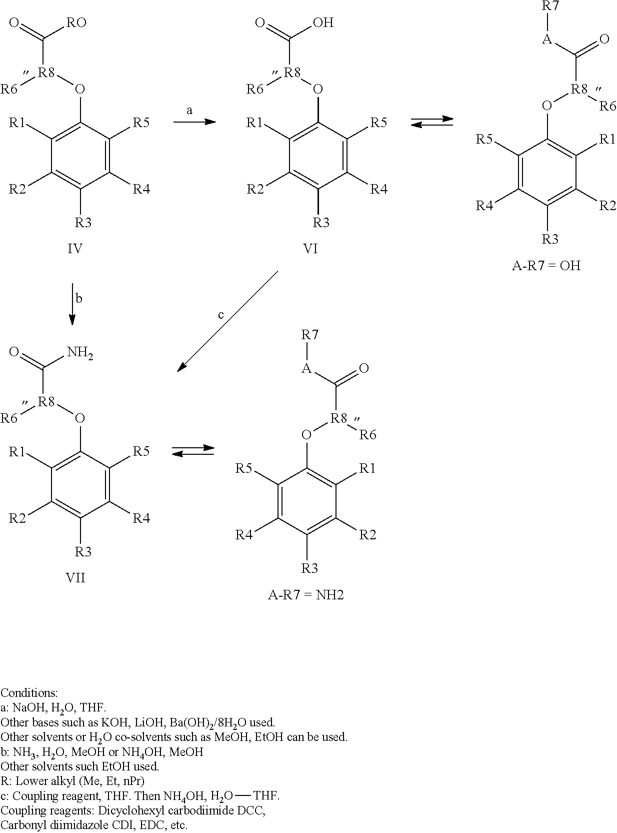

7.5 General Synthesis: Ester and Amide Formation

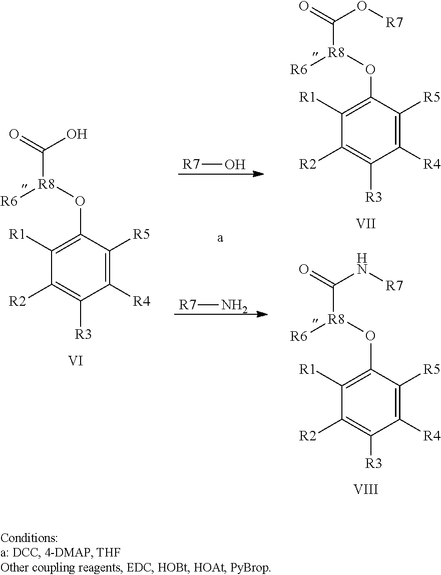

Alternative use of bases such as Et3N, DIPEA and solvents such as DCM, DMF.

Activation of carboxylic acid via acid chloride formation by treatment with, i.e., Oxalyl or Thionyl chloride.

7.6 Commercial Availability of Starting Compounds

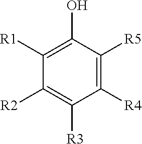

ca. 100 commercially available phenols (see Table 1)

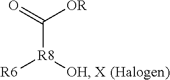

Ca. 100 commercially available hydroxyl-esters and halo-esters (see Table 2)

All the required starting materials are available in R, S and racemic forms, except the following substitution where the racemate is only available: R8: CH—CH2/R6:Et (rac).

The preparation of R and S required starting materials is reported in: Synlett, (3), 199-200, 1994; Org. Lett., Vol. 13, No. 16, 2011, Journal of the Chemical Society, Perkin Transactions 1: Organic and Bio-Organic Chemistry (1972-1999), (5), 897-903; 1989). R8: CH—CH2-CH2/R6: Et (rac). Preparation of R and S enantiomers is not reported. Chiral separation is needed to prepare the R and S compounds.

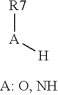

R7: alkane and substituted alkane, 191 commercially available (see Table 3)

7.7 Chemical Synthesis of Variant 1 (See Example 3)

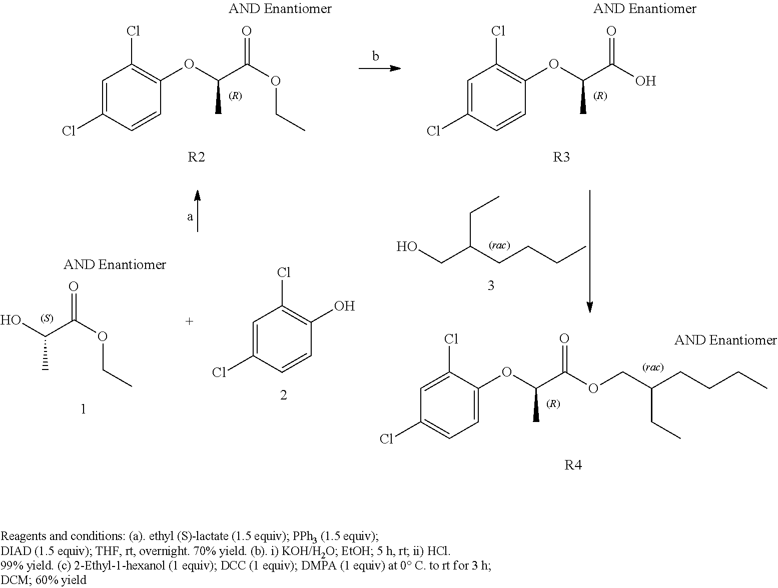

Procedure:

(a) Conditions from WO2010/118046 (Compound 9b=R-2)

To a solution of 2 (111 mg; 0.68 mmol), ethyl (S)-lactate 1 (88.4 mg; 0.75 mmol), and triphenylphosphine (262 mg; 1.0 mmol) in anhydrous THF (2 mL), was added diisopropylazodicarboxylate (198 mg; 1 mmol) dropwise. The reaction mixture was stirred overnight at rt. The solvent was evaporated and the residue was purified by chromatography column to yield R2 (126.3 mg; 70% yield).

(b) Conditions from WO2010/118046 (Compound 10b=R-3)

To a solution of KOH (0.4 g; 7.2 mmol) in H₂O (2 mL) was added R-2 (126.3 mg; 0.48 mmol) in EtOH (2 mL) at rt. The solution was stirred for 5 h and the acidified with concentrated aqueous HCl (pH 3). The resulting solid was filtered, rinsed with water and dried to give R-3 (113 mg; 99% yield)

c) Conditions Selected from Tetrahedron Asymm. 2001; 12; 3223

R-3 (113 mg; 0.48 mmol) was dissolved in dichloromethane (4 mL). DCC (99 mg; 0.48 mmol) was added to the solution, followed by the addition of DMAP (6 mg; 0.05 mmol) at 0° C. The reaction mixture was stirred for 5 min and a solution of 2-Ethyl-1-hexanol 3 (62.5 mg; 0.48 mmol) in dichloromethane (4 mL) was then added dropwise. The mixture was stirred for 3 hours at rt. Dicyclohexylurea was filtered off, and the filtrate was washed with water, brine and dried (Na₂SO4). After chromatographic separation the product was obtained R-4 (100 mg; 60% yield).

7.8 Synthesis of Variant 2 (See Example 3)

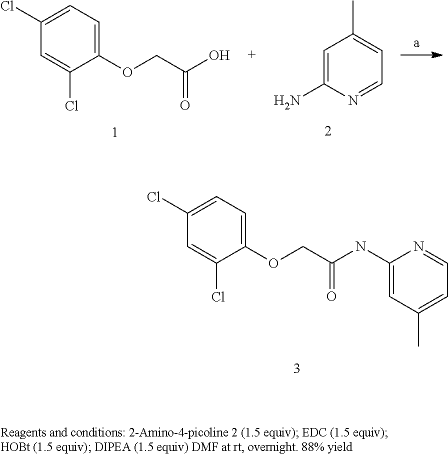

Procedure:

Conditions adapted from WO2008/004798 (Example 90=Compound 2)

To a solution of 1 (84 mg; 0.38 mmol), 2-Amino-4-picoline 2 (61.6 mg; 0.57 mmol) and DIPEA (102 μL; 0.42 mmol) in DMF (4 mL) were added EDC (109.3 mg; 0.57 mmol) and HOBt (77.6 mg; 0.57 mmol) at room temperature, and the reaction was stirred overnight. Resulting mixture was poured onto ice cold water and diluted with ethyl acetate. The organic phase was separated, washed with aqueous sodium bicarbonatem and brine, dried over MgSO4 and concentrated, the residue was purified by silica gel column chromatography (EtOAc/Hx) to result in 2 (110 mg; 88% yield).

7.9 Specific Synthesis of Compound 4 (See Examples 1 and 2)

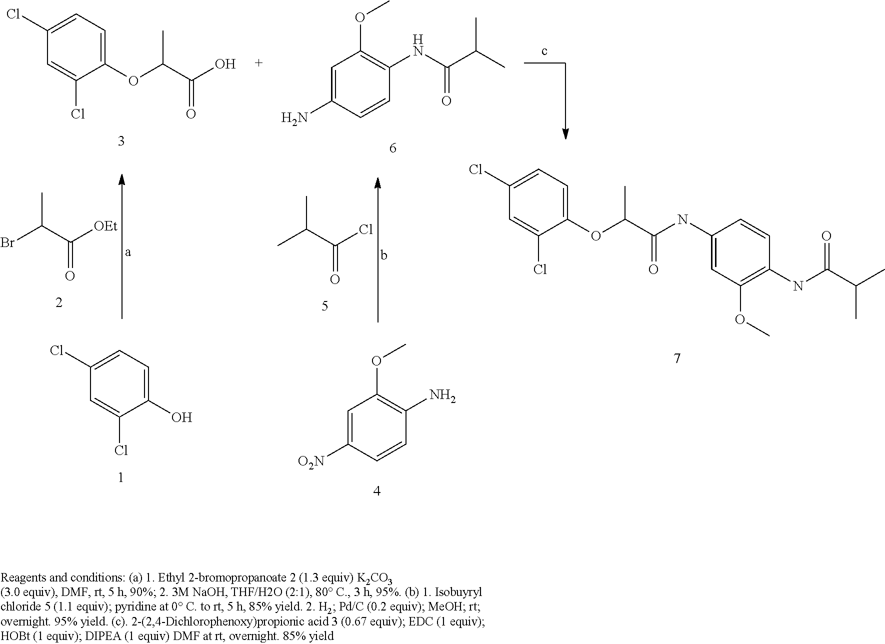

Procedure:

Conditions from J. Med. Chem., 2013, 56, 4028 (general synthesis of analogues, adapted for compound 4).

(a) To a solution of 2,4-dichlorophenol (200 mg, 1.22 mmol) in anhydrous DMF (15 mL) were added K2CO3 (505 mg, 3.66 mmol) and ethyl 2-bromopropionate (287.1 mg, 1.58 mmol). The reaction mixture was stirred at room temperature for 5 hours under a nitrogen atmosphere, diluted with water (50 mL), and extracted with ethyl acetate (3×50 mL). The organic extracts were combined, washed with brine, dried over anhydrous MgSO4, filtered, and concentrated in vacuo. The residue was purified by silica gel column chromatography using a mixture of ethyl acetate and n-hexane (10:90) to give ethyl 2-(2,4-dichlorophenoxy)propionate (290 mg, 1.2 mmol, 90%) as a colorless liquid.

The ester (290 mg, 1.60 mmol) was dissolved in THF/H2O (2:1), and then NaOH (132 mg, 3.3 mmol) was added. The reaction mixture was heated at 80° C. for 3 h. After the reaction mixture was allowed to cool to room temperature, 1N HCl was added until a pH of 7 was reached, and then the mixture was extracted with DCM. The organic layers were dried over anhydrous MgSO4, filtered, and concentrated. The residue was purified by silica gel column chromatography using a mixture of ethyl acetate/n-hexane (60:40) to afford 2-(2,4-dichlorophenoxy)propionic acid 3 (270 mg, 95%).

b) Conditions based on standard acylation and hydrogenation procedures.

Isobutyryl chloride (61.1 μL; 0.57 mmol) was added dropwise to a stirred solution of 1 (87.5 mg; 0.52 mmol) in anhydrous pyridine (4 mL) at 0° C. The mixture was warmed to room temperature and stirred for 5 h. Pyridine was removed under reduced pressure and the residue was washed with 10% acetic acid solution and water until neutrality. The crude product was dried in vacuo and used in the next step without further purification 2 (105 mg; 85% yield).

A solution of 2 (105 mg; 0.44 mmol) in MeOH (10 mL) was degassed with Ar for 5 minutes. After that, Palladium (10% wt on carbon; 93 mg; 0.09 mmol) was added. The resultant heterogeneous solution was allowed to stir under H₂ atmosphere at rt overnight. The mixture was filtered through a pad of celite washing with MeOH. The filtrate was concentrated to obtain 3 (87.5 mg; 95% yield).

c) Conditions extracted/adapted from WO2008/004798. To a solution of 2-(2,4-Dichlorophenoxy)propionic acid 3 (65 mg; 0.28 mmol), 6 (87.5 mg; 0.42 mmol), EDC (80.5 mg; 0.42 mmol) and HOBt (57.2 mg; 0.42 mmol) in DMF (2.8 mL) was added DIPEA (75 μL; 0.42 mmol), and the reaction was stirred overnight. Then the mixture was partitioned between ethyl acetate and brine. The organic phase was dried (MgSO4) and concentrated, the residue was purified by chromatography column to give 7 (100 mg; 85% yield).

TABLE 1
commercial available phenols

| CHEMISTRY | CAS number |
|---|---|
| Phenol, 4,6-dichloro-2,3-dimethyl- | CAS-10247-85-5 |
| Phenol, 2-chloro-3,4-dimethyl- | CAS-10283-15-5 |
| Phenol, 2,3,4,6-tetrachloro-5-methyl- | CAS-10460-33-0 |
| Phenol, 2,4-dimethyl- | CAS-105-67-9 |
| Phenol, 3-methyl- | CAS-108-39-4 |
| Phenol, 3-chloro- | CAS-108-43-0 |
| Phenol, 3,5-dimethyl- | CAS-108-68-9 |
| Phenol | CAS-108-95-2 |
| Phenol, 4-chloro-2,6-dimethyl- | CAS-1123-63-3 |
| Phenol, 2-chloro-4,5-dimethyl- | CAS-1124-04-5 |
| Phenol, 4-chloro-2,5-dimethyl- | CAS-1124-06-7 |
| Phenol, 2,4-dichloro-5-methyl- | CAS-1124-07-8 |
| Phenol, 2,4-dichloro- | CAS-120-83-2 |
| Phenol, 2,4-dichloro-3,5-dimethyl- | CAS-133-53-9 |
| Phenol, 2,6-dichloro-3-methyl- | CAS-13481-70-4 |
| Phenol, 4-methyl-, hydrate (1:1) | CAS-144255-42-5 |
| Phenol, 3,4-dichloro-2,6-dimethyl- | CAS-14486-35-2 |
| Phenol, 5-chloro-2,3-dimethyl- | CAS-146335-36-6 |
| Phenol, 4-chloro-2-methyl- | CAS-1570-64-5 |
| Phenol, 2,4-dichloro-6-methyl- | CAS-1570-65-6 |
| Phenol, 2,6-dichloro-3,4-dimethyl- | CAS-1570-67-8 |
| Phenol, 4-chloro-2,3-dimethyl- | CAS-1570-76-9 |
| Phenol, 2,3,4-trichloro- | CAS-15950-66-0 |
| Phenol, 3,6-dichloro-2-methyl- | CAS-16601-99-3 |
| Phenol, 3-chloro-2,4,6-trimethyl- | CAS-1667-05-6 |
| Phenol, 2,4-dichloro-3-methyl- | CAS-17788-00-0 |
| Phenol, hydrate (1:4) | CAS-180725-12-6 |
| Phenol, 4,5-dichloro-2,3-dimethyl- | CAS-182011-13-8 |
| Phenol, 2,3,4,5-tetrachloro-6-methyl- | CAS-19303-88-9 |
| Phenol, 2,6-dichloro-3,5-dimethyl- | CAS-1943-54-0 |
| Phenol, 3,4-dichloro-2-methyl- | CAS-204930-41-6 |
| Phenol, 2,4-dichloro-3,6-dimethyl- | CAS-2057-64-9 |
| Phenol, hydrate | CAS-217182-78-0 |
| Phenol, 2,3,6-trimethyl- | CAS-2416-94-6 |
| Phenol, 2,6-dichloro-4-methyl- | CAS-2432-12-4 |
| Phenol, 2,3,4,5,6-pentamethyl- | CAS-2819-86-5 |
| Phenol, 3,5-dichloro-4-methyl- | CAS-2985-62-8 |
| Phenol, 2,3,4,6-tetramethyl- | CAS-3238-38-8 |
| Phenol, 3-chloro-2-methyl- | CAS-3260-87-5 |
| Phenol, 2,3,4-trichloro-5,6-dimethyl- | CAS-36433-45-1 |
| Phenol, 2,4,5-trichloro-3,6-dimethyl- | CAS-36433-46-2 |
| Phenol, 4-chloro-2,3,6-trimethyl- | CAS-36433-51-9 |
| Phenol, 2-chloro-3,4,5-trimethyl- | CAS-38941-96-7 |
| Phenol, 2,5-dichloro-4-methyl- | CAS-38946-60-0 |
| Phenol, 2,3,4,5-tetramethyl- | CAS-488-70-0 |
| Phenol, 2,3,4,5-tetrachloro- | CAS-4901-51-3 |
| Phenol, 2,4,5-trimethyl- | CAS-496-78-6 |
| Phenol, 2,3-dimethyl- | CAS-526-75-0 |
| Phenol, 2,3,4-trimethyl- | CAS-526-85-2 |
| Phenol, 2,3,5,6-tetramethyl- | CAS-527-35-5 |
| Phenol, 3,4,5-trimethyl- | CAS-527-54-8 |
| Phenol, 2,4,6-trimethyl- | CAS-527-60-6 |
| Phenol, 4,5-dichloro-2-methyl- | CAS-52780-67-3 |
| Phenol, 5-chloro-2-methyl- | CAS-5306-98-9 |
| Phenol, 2,4,6-trichloro-3-methyl- | CAS-551-76-8 |
| Phenol, 2,3,6-trichloro-4-methyl- | CAS-551-77-9 |
| Phenol, 2,3,4-trichloro-6-methyl- | CAS-551-78-0 |
| Phenol, 2-chloro-3,5-dimethyl- | CAS-5538-41-0 |
| Phenol, 2,3,5-trichloro-4,6-dimethyl- | CAS-55776-56-2 |
| Phenol, 2,3,5,6-tetrachloro-4-methyl- | CAS-56680-65-0 |
| Phenol, 3,5-dichloro-2-methyl- | CAS-56680-66-1 |
| Phenol, 5-chloro-2,4-dimethyl- | CAS-56961-14-9 |
| Phenol, 6-chloro-2,3-dimethyl- | CAS-56961-15-0 |
| Phenol, 2,3-dichloro-5,6-dimethyl- | CAS-56961-17-2 |
| Phenol, 2,5-dichloro-3,4-dimethyl- | CAS-56961-18-3 |
| Phenol, 2,3-dichloro-4,5-dimethyl- | CAS-56961-19-4 |
| Phenol, 2,3-dichloro- | CAS-576-24-9 |
| Phenol, 2,6-dimethyl- | CAS-576-26-1 |
| Phenol, 3-chloro-5-methyl- | CAS-58291-77-3 |
| Phenol, 2,5-dichloro- | CAS-583-78-8 |
| Phenol, 3,5-dichloro- | CAS-591-35-5 |
| Phenol, 4-chloro-3-methyl- | CAS-59-50-7 |
| Phenol, 3-chloro-2,5,6-trimethyl- | CAS-59606-82-5 |
| Phenol, 2-chloro-3-methyl- | CAS-608-26-4 |
| Phenol, 3,4,5-trichloro- | CAS-609-19-8 |
| Phenol, 3-chloro-4-methyl- | CAS-615-62-3 |
| Phenol, 2-chloro-5-methyl- | CAS-615-74-7 |
| Phenol, 3,4,6-trichloro-2-methyl- | CAS-643-14-1 |
| Phenol, 4-chloro-2,3,5-trimethyl- | CAS-6627-94-7 |
| Phenol, 2-chloro-4-methyl- | CAS-6640-27-3 |
| Phenol, 2-chloro-4,6-dimethyl- | CAS-6641-04-9 |
| Phenol, 2,4-dichloro-3,5,6-trimethyl- | CAS-6965-74-8 |
| Phenol, 2,4,6-trichloro-3,5-dimethyl- | CAS-6972-47-0 |
| Phenol, 2,3,5-trimethyl- | CAS-697-82-5 |
| Phenol, 3-chloro-2,6-dimethyl- | CAS-70024-45-2 |
| Phenol, 2,5-dichloro-, hydrate (1:1) | CAS-848169-94-8 |
| Phenol, 2,6-dichloro-, hydrate (1:1) | CAS-848169-95-9 |
| Phenol, 2-chloro-6-methyl- | CAS-87-64-9 |
| Phenol, 2,6-dichloro- | CAS-87-65-0 |
| Phenol, 2,3,4,5,6-pentachloro- | CAS-87-86-5 |
| Phenol, 4-chloro-3,5-dimethyl- | CAS-88-04-0 |
| Phenol, 2,4,6-trichloro- | CAS-88-06-2 |
| Phenol, 2-chloro-3,5,6-trimethyl- | CAS-90416-29-8 |
| Phenol, 2,3,6-trichloro- | CAS-933-75-5 |
| Phenol, 2,3,5-trichloro- | CAS-933-78-8 |
| Phenol, 2,3,5,6-tetrachloro- | CAS-935-95-5 |
| Phenol, 3,4-dichloro-5-methyl- | CAS-94705-20-1 |
| Phenol, 2-methyl- | CAS-95-48-7 |
| Phenol, 2-chloro- | CAS-95-57-8 |
| Phenol, 3,4-dimethyl- | CAS-95-65-8 |
| Phenol, 3,4-dichloro- | CAS-95-77-2 |
| Phenol, 2,5-dimethyl- | CAS-95-87-4 |
| Phenol, 2,4,5-trichloro- | CAS-95-95-4 |

TABLE 2
commercial available hydroxyl-esters and halo-esters

| CHEMISTRY | R-TYPE | CAS Number |
|---|---|---|
| Butanoic acid, 2-bromo-, methyl ester, (2R)- | Et_Ac_R | CAS-114438-75-4 |
| Butanoic acid, 2-bromo-, ethyl ester, (2R)- | Et_Ac_R | CAS-130251-07-9 |
| Butanoic acid, 2-chloro-, ethyl ester, (2R)- | Et_Ac_R | CAS-1379444-26-4 |
| Butanoic acid, 2-hydroxy-, methyl ester, (2R)- | Et_Ac_R | CAS-73349-07-2 |
| Butanoic acid, 2-hydroxy-, ethyl ester, (2R)- | Et_Ac_R | CAS-87172-81-4 |
| Butanoic acid, 2-chloro-, methyl ester | Et_Ac_rac | CAS-26464-32-4 |
| Butanoic acid, 2-bromo-, methyl ester | Et_Ac_rac | CAS-3196-15-4 |
| Butanoic acid, 2-fluoro-, ethyl ester | Et_Ac_rac | CAS-327-46-8 |
| Butanoic acid, 2-bromo-, ethyl ester | Et_Ac_rac | CAS-533-68-6 |
| Butanoic acid, 2-bromo-, propyl ester | Et_Ac_rac | CAS-5459-97-2 |
| Butanoic acid, 2-chloro-, propyl ester | Et_Ac_rac | CAS-62108-71-8 |
| Butanoic acid, 2-chloro-, ethyl ester | Et_Ac_rac | CAS-7425-45-8 |
| Butanoic acid, 2-iodo-, ethyl ester | Et_Ac_rac | CAS-7425-47-0 |
| Butanoic acid, 2-hydroxy-, methyl ester | Et_Ac_rac | CAS-29674-47-3 |
| Butanoic acid, 2-hydroxy-, ethyl ester | Et_Ac_rac | CAS-52089-54-0 |
| Butanoic acid, 2-bromo-, methyl ester, (2S)- | Et_Ac_S | CAS-114438-76-5 |
| Butanoic acid, 2-bromo-, ethyl ester, (2S)- | Et_Ac_S | CAS-130233-25-9 |
| Butanoic acid, 2-chloro-, methyl ester, (2S)- | Et_Ac_S | CAS-692753-51-8 |
| Butanoic acid, 2-hydroxy-, methyl ester, (2S)- | Et_Ac_S | CAS-73349-08-3 |
| Butanoic acid, 2-hydroxy-, ethyl ester, (2S)- | Et_Ac_S | CAS-88271-13-0 |
| Butanoic acid, 2-ethyl-4-hydroxy-, methyl ester | Et_But_rac | CAS-952015-55-3 |
| Butanoic acid, 2-(chloromethyl)-, ethyl ester | ET_Pr_rac | CAS-1314920-97-2 |
| Butanoic acid, 2-(chloromethyl)-, methyl ester | ET_Pr_rac | CAS-82504-42-5 |
| Butanoic acid, 2-(hydroxymethyl)-, methyl ester | Et_Pr_rac | CAS-56970-75-3 |
| Butanoic acid, 2-(hydroxymethyl)-, ethyl ester | Et_Pr_rac | CAS-99437-71-5 |
| Acetic acid, 2-bromo-, ethyl ester | H_Ac | CAS-105-36-2 |
| Acetic acid, 2-chloro-, ethyl ester | H_Ac | CAS-105-39-5 |
| Acetic acid, 2-bromo-, propyl ester | H_Ac | CAS-35223-80-4 |
| Acetic acid, 2-fluoro-, methyl ester | H_Ac | CAS-453-18-9 |
| Acetic acid, 2-fluoro-, ethyl ester | H_Ac | CAS-459-72-3 |
| Acetic acid, 2-iodo-, methyl ester | H_Ac | CAS-5199-50-8 |
| Acetic acid, 2-chloro-, propyl ester | H_Ac | CAS-5396-24-7 |
| Acetic acid, 2-iodo-, ethyl ester | H_Ac | CAS-623-48-3 |
| Acetic acid, 2-bromo-, methyl ester | H_Ac | CAS-96-32-2 |
| Acetic acid, 2-chloro-, methyl ester | H_Ac | CAS-96-34-4 |
| Acetic acid, 2-hydroxy-, methyl ester | H_Ac | CAS-96-35-5 |
| Acetic acid, 2-hydroxy-, ethyl ester | H_Ac | CAS-623-50-7 |
| Butanoic acid, 4-iodo-, methyl ester | H_Bu | CAS-14273-85-9 |
| Butanoic acid, 4-bromo-, ethyl ester | H_Bu | CAS-2969-81-5 |
| Butanoic acid, 4-chloro-, propyl ester | H_Bu | CAS-3153-35-3 |
| Butanoic acid, 4-chloro-, ethyl ester | H_Bu | CAS-3153-36-4 |
| Butanoic acid, 4-chloro-, methyl ester | H_Bu | CAS-3153-37-5 |
| Butanoic acid, 4-fluoro-, methyl ester | H_Bu | CAS-406-20-2 |
| Butanoic acid, 4-bromo-, methyl ester | H_Bu | CAS-4897-84-1 |
| Butanoic acid, 4-fluoro-, ethyl ester | H_Bu | CAS-63904-96-1 |
| Butanoic acid, 4-iodo-, ethyl ester | H_Bu | CAS-7425-53-8 |
| Butanoic acid, 4-hydroxy-, methyl ester | H_Bu | CAS-925-57-5 |
| Butanoic acid, 4-hydroxy-, ethyl ester | H_Bu | CAS-999-10-0 |
| Propanoic acid, 3-fluoro-, ethyl ester | H_Pr | CAS-10117-10-9 |
| Propanoic acid, 3-bromo-, methyl ester | H_Pr | CAS-3395-91-3 |
| Propanoic acid, 3-bromo-, propyl ester | H_Pr | CAS-4890-42-0 |
| Propanoic acid, 3-iodo-, methyl ester | H_Pr | CAS-5029-66-3 |
| Propanoic acid, 3-bromo-, ethyl ester | H_Pr | CAS-539-74-2 |
| Propanoic acid, 3-chloro-, methyl ester | H_Pr | CAS-6001-87-2 |
| Propanoic acid, 3-chloro-, propyl ester | H_Pr | CAS-62108-66-1 |
| Propanoic acid, 3-chloro-, ethyl ester | H_Pr | CAS-623-71-2 |
| Propanoic acid, 3-iodo-, ethyl ester | H_Pr | CAS-6414-69-3 |
| Propanoic acid, 3-hydroxy-, methyl ester | H_Pr | CAS-6149-41-3 |
| Propanoic acid, 3-hydroxy-, ethyl ester | H_Pr | CAS-623-72-3 |
| Propanoic acid, 2-fluoro, methyl ester, (2R)- | Me_Ac_R | CAS-146805-74-5 |
| Propanoic acid, 2-bromo-, methyl ester, (2R)- | Me_Ac_R | CAS-20047-41-0 |
| Propanoic acid, 2-chloro-, ethyl ester, (2R)- | Me_Ac_R | CAS-42411-39-2 |
| Propanoic acid, 2-bromo-, ethyl ester, (2R)- | Me_Ac_R | CAS-51063-99-1 |
| Propanoic acid, 2-fluoro-, ethyl ester, (2R)- | Me_Ac_R | CAS-72959-94-5 |
| Propanoic acid, 2-chloro-, methyl ester, (2R)- | Me_Ac_R | CAS-77287-29-7 |
| Propanoic acid, 2-chloro-, propyl ester, (R)- | Me_Ac_R | CAS-79398-17-7 |
| Propanoic acid, 2-hydroxy-, methyl ester, (2R)- | Me_Ac_R | CAS-17392-83-5 |
| Propanoic acid, 2-hydroxy-, ethyl ester, (2R)- | Me_Ac_R | CAS-7699-00-5 |
| Propanoic acid, 2-bromo-, propyl ester | Me_Ac_rac | CAS-10259-96-8 |
| Propanoic acid, 2-chloro-, propyl ester | Me_Ac_rac | CAS-1569-03-5 |
| Propanoic acid, 2-chloro-, methyl ester | Me_Ac_rac | CAS-17639-93-9 |
| Propanoic acid, 2-fluoro-, methyl ester | Me_Ac_rac | CAS-2366-56-5 |
| Propanoic acid, 2-iodo-, ethyl ester | Me_Ac_rac | CAS-31253-08-4 |
| Propanoic acid, 2-fluoro-, ethyl ester | Me_Ac_rac | CAS-349-43-9 |
| Propanoic acid, 2-bromo-, ethyl ester | Me_Ac_rac | CAS-535-11-5 |
| Propanoic acid, 2-chloro-, ethyl ester | Me_Ac_rac | CAS-535-13-7 |
| Propanoic acid, 2-bromo-, methyl ester | Me_Ac_rac | CAS-5445-17-0 |
| Propanoic acid, 2-hydroxy-, methyl ester | Me_Ac_rac | CAS-547-64-8 |
| Propanoic acid, 2-hydroxy-, ethyl ester | Me_Ac_rac | CAS-97-64-3 |
| Propanoic acid, 2-bromo-, ethyl ester, (2S)- | Me_Ac_S | CAS-30365-54-9 |
| Propanoic acid, 2-fluoro-, methyl ester, (2S)- | Me_Ac_S | CAS-325690-13-9 |
| Propanoic acid, 2-bromo-, methyl ester, (2S)- | Me_Ac_S | CAS-62076-23-7 |
| Propanoic acid, 2-chloro-, methyl ester, (2S)- | Me_Ac_S | CAS-73246-45-4 |
| Propanoic acid, 2-chloro-, ethyl ester, (2S)- | Me_Ac_S | CAS-74497-15-7 |
| Propanoic acid, 2-hydroxy-, methyl ester, (2S)- | Me_Ac_S | CAS-27871-49-4 |
| Propanoic acid, 2-hydroxy-, ethyl ester, (2S)- | Me_Ac_S | CAS-687-47-8 |
| Butanoic acid, 4-chloro-2-methyl-, methyl ester | Me_Bu_rac | CAS-13888-03-4 |
| Butanoic acid, 4-bromo-2-methyl-, ethyl ester | Me_Bu_rac | CAS-2213-09-4 |
| Butanoic acid, 4-bromo-2-methyl-, methyl ester | Me_Bu_rac | CAS-58029-83-7 |
| Butanoic acid, 4-chloro-2-methyl-, ethyl ester | Me_Bu_rac | CAS-70786-83-3 |
| Butanoic acid, 4-chloro-2-methyl-, ethyl ester, (S)- (9CI) | Me_Bu_S | CAS-65528-02-1 |
| Propanoic acid, 3-iodo-2-methyl-, methyl ester, (2R)- | Me_Pr_R | CAS-110556-30-4 |
| Propanoic acid, 3-bromo-2-methyl-, methyl ester, (2R)- | Me_Pr_R | CAS-110556-33-7 |
| Propanoic acid, 3-chloro-2-methyl-, methyl ester, (2R)- | Me_Pr_R | CAS-118417-75-7 |
| Propanoic acid, 3-hydroxy-2-methyl-, methyl ester, (2R)- | Me_Pr_R | CAS-72657-23-9 |
| Propanoic acid, 3-chloro-2-methyl-, methyl ester | Me_Pr_rac | CAS-10317-11-0 |
| Propanoic acid, 3-bromo-2-methyl-, methyl ester | Me_Pr_rac | CAS-20609-71-6 |
| Propanoic acid, 3-fluoro-2-methyl-, methyl ester | Me_Pr_rac | CAS-2253-38-5 |
| Propanoic acid, 3-bromo-2-methyl-, ethyl ester | Me_Pr_rac | CAS-59154-46-0 |
| Propanoic acid, 3-chloro-2-methyl-, ethyl ester | Me_Pr_rac | CAS-922-29-2 |
| Propanoic acid, 3-chloro-2-methyl-, propyl ester | Me_Pr_rac | CAS-98610-86-7 |
| Propanoic acid, 3-hydroxy-2-methyl-, methyl ester | Me_Pr_rac | CAS-42998-03-8 |
| Propanoic acid, 3-hydroxy-2-methyl-, ethyl ester | Me_Pr_rac | CAS-89534-52-1 |
| Propanoic acid, 3-bromo-2-methyl-, methyl ester, (2S)- | Me_Pr_S | CAS-98190-85-3 |
| Propanoic acid, 3-hydroxy-2-methyl-, methyl ester, (S)-, | Me_Pr_S | CAS-176648-55-8 |
| homopolymer (9CI) | | |
| Propanoic acid, 3-hydroxy-2-methyl-, methyl ester, (2S)- | Me_Pr_S | CAS-80657-57-4 |

TABLE 3
commercial available alkanes and substituted alkanes

| CHEMISTRY | CAS Number |
|---|---|
| 1-Butanamine | CAS-109-73-9 |
| 1-Butanamine, 2-ethyl- | CAS-617-79-8 |
| 1-Butanamine, 2-methyl- | CAS-96-15-1 |
| 1-Butanamine, 2-methyl-, (2R)- | CAS-36272-22-7 |
| 1-Butanamine, 2-methyl-, (2S)- | CAS-34985-37-0 |
| 1-Butanamine, 3-methyl- | CAS-107-85-7 |
| 1-Butanol | CAS-71-36-3 |
| 1-Butanol, 2-ethyl- | CAS-97-95-0 |
| 1-Butanol, 2-methyl- | CAS-137-32-6 |
| 1-Butanol, 2-methyl-, (2R)- | CAS-616-16-0 |
| 1-Butanol, 2-methyl-, (2S)- | CAS-1565-80-6 |
| 1-Butanol, 3-methyl- | CAS-123-51-3 |
| 1-Heptanamine | CAS-111-68-2 |
| 1-Heptanamine, 2-ethyl- | CAS-201485-30-5 |
| 1-Heptanamine, 2-methyl- | CAS-101084-50-8 |
| 1-Heptanamine, 2-methyl-, (2R)- | CAS-1196891-12-9 |
| 1-Heptanamine, 2-propyl- | CAS-194608-78-1 |
| 1-Heptanamine, 3-ethyl- | CAS-13887-73-5 |
| 1-Heptanamine, 3-methyl- | CAS-75854-67-0 |
| 1-Heptanamine, 3-methyl-, (3S)- | CAS-1315053-61-2 |
| 1-Heptanamine, 4-methyl- | CAS-910887-94-4 |
| 1-Heptanamine, 4-methyl-, (4R)- | CAS-1315053-85-0 |
| 1-Heptanamine, 4-propyl- | CAS-1000507-52-7 |
| 1-Heptanamine, 5-ethyl- | CAS-1339846-64-8 |
| 1-Heptanamine, 5-methyl- | CAS-44839-43-2 |
| 1-Heptanamine, 5-methyl-, (5S)- | CAS-927821-01-0 |
| 1-Heptanamine, 6-methyl- | CAS-44855-53-0 |
| 1-Heptanol | CAS-111-70-6 |
| 1-Heptanol, 2-ethyl- | CAS-817-60-7 |
| 1-Heptanol, 2-methyl- | CAS-60435-70-3 |
| 1-Heptanol, 2-propyl- | CAS-10042-59-8 |
| 1-Heptanol, 3-ethyl- | CAS-3525-25-5 |
| 1-Heptanol, 3-methyl- | CAS-1070-32-2 |
| 1-Heptanol, 3-methyl-, (3R)- | CAS-99427-18-6 |
| 1-Heptanol, 3-methyl-, (3S)- | CAS-61169-84-4 |
| 1-Heptanol, 3-propyl- | CAS-1205686-72-1 |
| 1-Heptanol, 4-methyl- | CAS-817-91-4 |
| 1-Heptanol, 4-propyl- | CAS-2768-17-4 |
| 1-Heptanol, 5-ethyl- | CAS-998-65-2 |
| 1-Heptanol, 5-methyl- | CAS-7212-53-5 |
| 1-Heptanol, 5-methyl-, (5S)- | CAS-57803-73-3 |
| 1-Heptanol, 6-methyl- | CAS-1653-40-3 |
| 1-Hexanamine | CAS-111-26-2 |
| 1-Hexanamine, 2-ethyl- | CAS-104-75-6 |
| 1-Hexanamine, 2-ethyl-, (2R)- | CAS-127419-43-6 |
| 1-Hexanamine, 2-ethyl-, (2S)- | CAS-127419-44-7 |
| 1-Hexanamine, 2-methyl- | CAS-44652-67-7 |
| 1-Hexanamine, 2-methyl-, (2R)- | CAS-72656-70-3 |
| 1-Hexanamine, 2-methyl-, (2S)- | CAS-683202-33-7 |
| 1-Hexanamine, 2-propyl- | CAS-857818-18-9 |
| 1-Hexanamine, 3-methyl- | CAS-65530-93-0 |
| 1-Hexanamine, 3-methyl-, (3S)- | CAS-1315053-81-6 |
| 1-Hexanamine, 3-propyl- | CAS-944886-84-4 |
| 1-Hexanamine, 4-ethyl- | CAS-1000510-56-4 |
| 1-Hexanamine, 4-methyl- | CAS-34263-68-8 |
| 1-Hexanamine, 4-methyl-, (4S)- | CAS-927820-99-3 |
| 1-Hexanamine, 5-methyl- | CAS-4746-31-0 |
| 1-Hexanol | CAS-111-27-3 |
| 1-Hexanol, 2-ethyl- | CAS-104-76-7 |
| 1-Hexanol, 2-methyl- | CAS-624-22-6 |
| 1-Hexanol, 2-propyl- | CAS-817-46-9 |
| 1-Hexanol, 3-methyl- | CAS-13231-81-7 |
| 1-Hexanol, 3-methyl-, (3R)- | CAS-86423-92-9 |
| 1-Hexanol, 3-methyl-, (3S)- | CAS-70575-26-7 |
| 1-Hexanol, 3-propyl- | CAS-66793-85-9 |
| 1-Hexanol, 4-ethyl- | CAS-66576-32-7 |
| 1-Hexanol, 4-methyl- | CAS-818-49-5 |
| 1-Hexanol, 4-methyl-, (4S)- | CAS-1767-46-0 |
| 1-Hexanol, 5-methyl- | CAS-627-98-5 |
| 1-Nonanol, 7-methyl- | CAS-33234-93-4 |
| 1-Nonanol, 7-methyl-, (7S)- | CAS-170212-05-2 |
| 1-Octanamine | CAS-111-86-4 |
| 1-Octanamine, 2-ethyl- | CAS-103859-34-3 |
| 1-Octanamine, 2-methyl- | CAS-1081974-54-0 |
| 1-Octanamine, 2-methyl-, (2S)- | CAS-89999-53-1 |
| 1-Octanamine, 2-methyl-, | CAS-89999-54-2 |
| (R)- (9CI) | |
| 1-Octanamine, 2-propyl- | CAS-1251230-01-9 |
| 1-Octanamine, 3-methyl- | CAS-75865-51-9 |
| 1-Octanamine, 3-methyl-, (3S)- | CAS-1315054-71-7 |
| 1-Octanamine, 4-ethyl- | CAS-103859-35-4 |
| 1-Octanamine, 4-methyl-, (4S)- | CAS-1315023-97-2 |
| 1-Octanamine, 5-methyl- | CAS-1340106-87-7 |
| 1-Octanamine, 7-methyl - | CAS-50782-86-0 |
| 1-Octanol | CAS-111-87-5 |
| 1-Octanol, 2-ethyl- | CAS-20592-10-3 |
| 1-Octanol, 2-ethyl-, (2S)- | CAS-123493-73-2 |
| 1-Octanol, 2-methyl- | CAS-818-81-5 |
| 1-Octanol, 2-methyl-, (2S)- | CAS-116013-69-5 |
| 1-Octanol, 2-propyl- | CAS-38514-11-3 |
| 1-Octanol, 4-ethyl- | CAS-38514-07-7 |
| 1-Octanol, 5-methyl- | CAS-38514-04-4 |
| 1-Octanol, 6-methyl- | CAS-38514-05-5 |
| 1-Octanol, 6-methyl-, (6S)- | CAS-110453-78-6 |
| 1-Octanol, 7-methyl- | CAS-2430-22-0 |
| 1-Pentanamine | CAS-110-58-7 |
| 1-Pentanamine, 2-ethyl- | CAS-90831-93-9 |
| 1-Pentanamine, 2-methyl- | CAS-13364-16-4 |
| 1-Pentanamine, 2-methyl-, (2S)- | CAS-1315050-34-0 |
| 1-Pentanamine, 2-methyl-, | CAS-74669-69-5 |
| (R)- (9CI) | |
| 1-Pentanamine, 2-propyl- | CAS-40755-20-2 |
| 1-Pentanamine, 3-ethyl- | CAS-66643-81-0 |
| 1-Pentanamine, 3-methyl- | CAS-42245-37-4 |
| 1-Pentanamine, 3-methyl-, (3R)- | CAS-927820-97-1 |
| 1-Pentanamine, 3-methyl-, (3S)- | CAS-42072-55-9 |
| 1-Pentanamine, 4-methyl- | CAS-5344-20-7 |
| 1-Pentanol | CAS-71-41-0 |
| 1-Pentanol, 2-ethyl- | CAS-27522-11-8 |
| 1-Pentanol, 2-methyl- | CAS-105-30-6 |
| 1-Pentanol, 2-methyl-, (2R)- | CAS-17092-41-0 |
| 1-Pentanol, 2-methyl-, (2S)- | CAS-17092-42-1 |
| 1-Pentanol, 2-propyl- | CAS-58175-57-8 |
| 1-Pentanol, 3-ethyl- | CAS-66225-51-2 |
| 1-Pentanol, 3-methyl- | CAS-589-35-5 |
| 1-Pentanol, 3-methyl-, (3S)- | CAS-42072-39-9 |
| 1-Pentanol, 4-methyl- | CAS-626-89-1 |
| 1-Propanamine | CAS-107-10-8 |
| 1-Propanamine, 2-methyl- | CAS-78-81-9 |
| 1-Propanol | CAS-71-23-8 |
| 1-Propanol, 2-methyl- | CAS-78-83-1 |
| 2-Butanamine | CAS-13952-84-6 |
| 2-Butanamine, (2R)- (9CI) | CAS-13250-12-9 |
| 2-Butanamine, (2S)- | CAS-513-49-5 |
| 2-Butanol | CAS-78-92-2 |
| 2-Butanol, (2R)- (9CI) | CAS-14898-79-4 |
| 2-Butanol, (2S)- (9CI) | CAS-4221-99-2 |
| 2-Heptanamine | CAS-123-82-0 |
| 2-Heptanamine, (2R)- | CAS-6240-90-0 |
| 2-Heptanamine, (2S)- | CAS-44745-29-1 |
| 2-Heptanol | CAS-543-49-7 |
| 2-Heptanol, (2R)- | CAS-6033-24-5 |
| 2-Heptanol, (2S)- | CAS-6033-23-4 |
| 2-Hexanamine | CAS-5329-79-3 |
| 2-Hexanamine, (2R)- | CAS-70095-40-8 |
| 2-Hexanamine, (2S)- | CAS-70492-67-0 |
| 2-Hexanol | CAS-626-93-7 |
| 2-Hexanol, (2R)- | CAS-26549-24-6 |
| 2-Hexanol, (2S)- | CAS-52019-78-0 |
| 2-Nonanamine | CAS-13205-58-8 |
| 2-Nonanamine, (2R)- | CAS-74069-74-2 |
| 2-Nonanamine, (2S)- | CAS-869278-88-6 |
| 2-Nonanol | CAS-628-99-9 |
| 2-Nonanol, (2R)- | CAS-70419-07-7 |
| 2-Nonanol, (2S)- | CAS-70419-06-6 |
| 2-Octanamine | CAS-693-16-3 |
| 2-Octanamine, (2R)- | CAS-34566-05-7 |
| 2-Octanamine, (2S)- | CAS-34566-04-6 |
| 2-Octanol | CAS-123-96-6 |
| 2-Octanol, (2R)- | CAS-5978-70-1 |
| 2-Octanol, (2S)- | CAS-6169-06-8 |
| 2-Pentanamine | CAS-63493-28-7 |
| 2-Pentanamine, (2R)- | CAS-33985-20-5 |
| 2-Pentanamine, (2S)- | CAS-54542-13-1 |
| 2-Pentanol | CAS-6032-29-7 |
| 2-Pentanol, (2R)- | CAS-31087-44-2 |
| 2-Pentanol, (2S)- | CAS-26184-62-3 |
| 2-Propanamine | CAS-75-31-0 |
| 2-Propanol | CAS-67-63-0 |
| 3-Decanamine | CAS-67232-53-5 |
| 3-Decanol | CAS-1565-81-7 |
| 3-Heptanamine | CAS-28292-42-4 |
| 3-Heptanamine, (3R)- | CAS-130232-58-5 |
| 3-Heptanamine, (3S)- | CAS-130232-57-4 |
| 3-Heptanol | CAS-589-82-2 |
| 3-Hexanamine | CAS-16751-58-9 |
| 3-Hexanamine, (3S)- | CAS-70218-55-2 |
| 3-Hexanamine, (R)- (9CI) | CAS-63731-10-2 |
| 3-Hexanol | CAS-623-37-0 |
| 3-Nonanamine | CAS-33787-95-0 |
| 3-Nonanamine, (3S)- | CAS-1315050-85-1 |
| 3-Nonanol | CAS-624-51-1 |
| 3-Nonanol, (3S)- | CAS-61925-49-3 |
| 3-Octanamine | CAS-24552-04-3 |
| 3-Octanol | CAS-589-98-0 |
| 3-Octanol, (3R)- | CAS-70492-66-9 |
| 3-Octanol, (3S)- | CAS-22658-92-0 |
| 3-Pentanamine | CAS-616-24-0 |
| 3-Pentanol | CAS-584-02-1 |
| 4-Decanamine | CAS-67232-52-4 |
| 4-Decanol | CAS-2051-31-2 |
| 4-Decanol, (4S)- | CAS-120523-18-4 |
| 4-Heptanamine | CAS-16751-59-0 |
| 4-Heptanol | CAS-589-55-9 |
| 4-Nonanamine | CAS-33787-96-1 |
| 4-Nonanamine, (4S)- | CAS-1314999-32-0 |
| 4-Nonanol | CAS-5932-79-6 |
| 4-Octanamine | CAS-1117-33-5 |
| 4-Octanol | CAS-589-62-8 |
| 4-Undecanamine | CAS-33787-97-2 |
| 4-Undecanol | CAS-4272-06-4 |
| Ethanamine | CAS-75-04-7 |
| Ethanol | CAS-64-17-5 |

1. A method of inducing abiotic stress tolerance in a plant, the method comprising:
administering to the plant a compound of formula (I) or a stereoisomer, a tautomer, a hydrate, a solvate, or a salt thereof 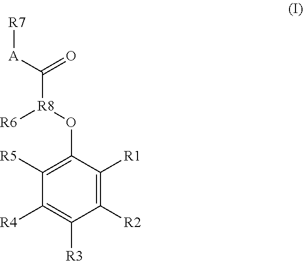
wherein in (I), R1 is halogen, hydrogen or methyl, R2 is halogen, hydrogen or methyl, R3 is halogen, hydrogen or methyl, R4: halogen, hydrogen or methyl, R5 is halogen, hydrogen or methyl, R6 is hydrogen, methyl or ethyl, A is O or N, R8 is (CH)ₙ wherein n=1, 2 or 3, and R7 is H or a linear alkane (alkane is 1 to 8) or a substituted linear alkane, or alkene, or alkyne wherein said substituent can be on any place of the linear alkane or alkene or alkyne with a length of 1 to 3 carbons or wherein R7 is a substituted or non-substituted unsaturated, partly saturated or aromatic group wherein the molecular weight of R7 is lower than 250 Dalton,
so as to induce abiotic stress tolerance in the plant.

2. The method according to claim 1, wherein said compound is selected from the group consisting of

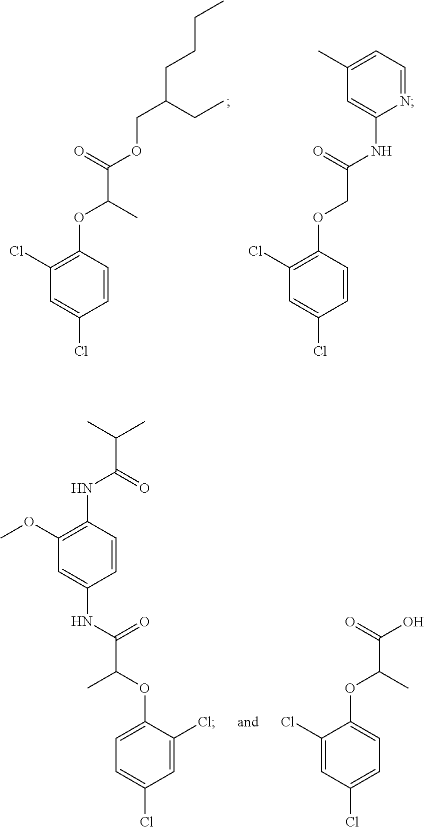 [SMILES: CCCCC(CC)COC(=O)C(C)Oc1ccc(Cl)cc1Cl ; Cc1ccnc(NC(=O)COc2ccc(Cl)cc2Cl)c1 ; COc1cc(NC(=O)C(C)Oc2ccc(Cl)cc2Cl)ccc1NC(=O)C(C)C ; CC(Oc1ccc(Cl)cc1Cl)C(=O)O]

3. An agrochemical formation comprising:
a compound of formula (I) or a stereoisomer, a tautomer, a hydrate, a solvate, or a salt thereof 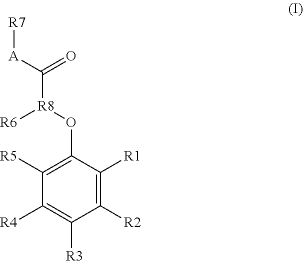
wherein, in (I), R1 is halogen, hydrogen or methyl, R2 is halogen, hydrogen or methyl, R3 is halogen, hydrogen or methyl, R4: halogen, hydrogen or methyl, R5 is halogen, hydrogen or methyl, R6 is hydrogen, methyl or ethyl, A is O or N, R8 is (CH)ₙ wherein n=1, 2 or 3, and R7 is H or a linear alkane (alkane is 1 to 8) or a substituted linear alkane, or alkene, or alkyne wherein said substituent can be on any place of the linear alkane or alkene or alkyne with a length of 1 to 3 carbons or wherein R7 is a substituted or non-substituted unsaturated, partly saturated or aromatic group, wherein the molecular weight of R7 is lower than 250 Dalton, and
a carrier.

4. The method according to claim 1, wherein said abiotic stress tolerance comprises salt tolerance, drought tolerance or frost tolerance.

5. The agrochemical formation of claim 3, wherein the compound is selected from the group consisting of

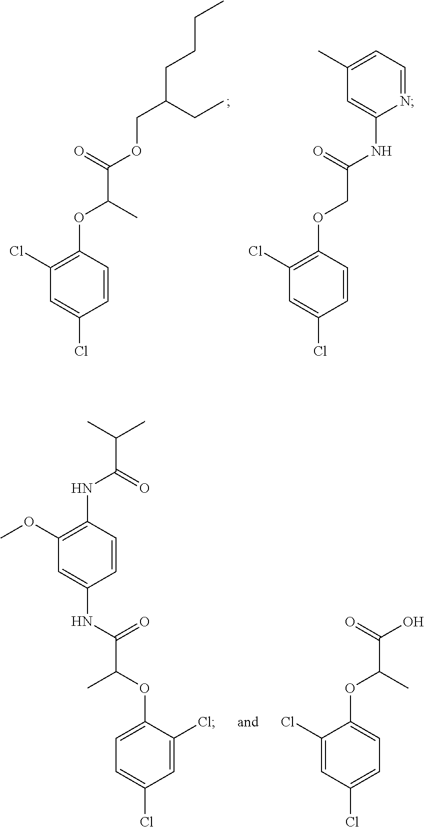 [SMILES: CCCCC(CC)COC(=O)C(C)Oc1ccc(Cl)cc1Cl ; Cc1ccnc(NC(=O)COc2ccc(Cl)cc2Cl)c1 ; COc1cc(NC(=O)C(C)Oc2ccc(Cl)cc2Cl)ccc1NC(=O)C(C)C ; CC(Oc1ccc(Cl)cc1Cl)C(=O)O]

6. The agrochemical formation of claim 5, wherein the compound is

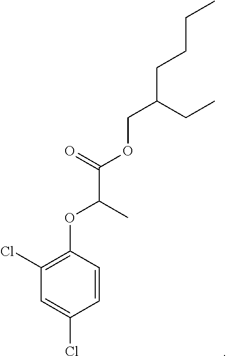 [SMILES: CCCCC(CC)COC(=O)C(C)Oc1ccc(Cl)cc1Cl]

7. The agrochemical formation of claim 5, wherein the compound is

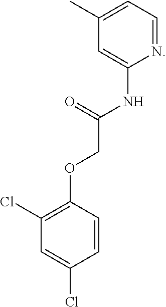 [SMILES: Cc1ccnc(NC(=O)COc2ccc(Cl)cc2Cl)c1]

8. The agrochemical formation of claim 5, wherein the compound is

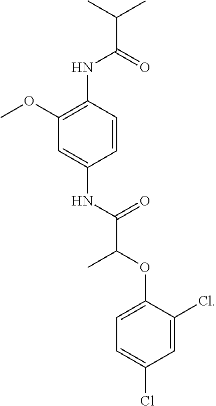 [SMILES: COc1cc(NC(=O)C(C)Oc2ccc(Cl)cc2Cl)ccc1NC(=O)C(C)C]

9. The agrochemical formation of claim 5, wherein the compound is

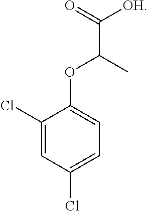

10. A method of inducing abiotic stress tolerance in a plant, the method comprising:
administering the agricultural formulation of claim 5 to the plant.

11. The method according to claim 10, wherein the abiotic stress tolerance comprises salt tolerance, drought tolerance, or frost tolerance.

12. A method of inducing abiotic stress tolerance in a plant, the method comprising:
administering the agricultural formulation of claim 6 to the plant.

13. The method according to claim 12, wherein the abiotic stress tolerance comprises salt tolerance, drought tolerance, or frost tolerance.

14. A method of inducing abiotic stress tolerance in a plant, the method comprising:
administering the agricultural formulation of claim 7 to the plant.

15. The method according to claim 14, wherein the abiotic stress tolerance comprises salt tolerance, drought tolerance, or frost tolerance.

16. A method of inducing abiotic stress tolerance in a plant, the method comprising:
administering the agricultural formulation of claim 8 to the plant.

17. The method according to claim 16, wherein the abiotic stress tolerance comprises salt tolerance, drought tolerance, or frost tolerance.

18. A method of inducing abiotic stress tolerance in a plant, the method comprising:
administering the agricultural formulation of claim 9 to the plant.

19. The method according to claim 18, wherein the abiotic stress tolerance comprises salt tolerance, drought tolerance, or frost tolerance.
